(19) United States
(12) Patent Application Publication
(10) Pub. No.: US 2022/0188943 A1
(43) Pub. Date: Jun. 16, 2022

(54) SIMULATION AND PREDICTION PLATFORM SERVICES IN INTEGRATED SYSTEM ENVIRONMENT

(71) Applicant: SAP SE, Walldorf (DE)

(72) Inventors: Marcus Krug, Berlin/Potsdam (DE); Christian Karaschewitz, Berlin/Potsdam (DE); Michael Wulf, Bad Schoenborn (DE); Sanjay Kumar Raina, Jammu Tawi (IN); Sebastian Schlunke, Berlin/Potsdam (DE); Cornelius Bock, Berlin/Potsdam (DE); Nicola Zanon, Berlin (DE); Serhii Dolia, Berlin (DE)

(21) Appl. No.: 17/122,039

(22) Filed: Dec. 15, 2020

(51) Int. Cl. G06Q 40/00; G06F 30/20; G06Q 10/10; G06Q 20/40; G06Q 10/06; G06Q 40/02; G06N 3/04

(52) U.S. Cl. CPC G06Q 40/125; G06F 30/20; G06Q 10/1091; G06Q 10/1053; G06N 3/08; G06Q 10/06398; G06Q 10/067; G06Q 40/02; G06N 3/0427; G06Q 20/405

(57) ABSTRACT

The present disclosure relates to computer-implemented methods, software, and systems for calculating an available balance amount for allocation to a user. A request from a user for an advance payment associated with a requested period of time is received by a platform service. The platform service is integrated with a plurality of systems storing data for employees of an enterprise. The requested period of time includes working days of the user. The user is identified as an employee of the enterprise in at least one of the plurality of systems. In response to the received request, an available balance amount that can be allocated to the user for the requested period of time is calculated. Calculating the available balance amount comprises determining data associated with the requested period of time to provide a base for calculating the available balance amount.

### TECHNICAL FIELD

The present disclosure relates to computer-implemented methods, software, and systems for data processing in a cloud platform environment.

### BACKGROUND

Software applications may execute processes related to providing user-requested services. Some applications provide financial services to support people's needs for funds to financially subsidize their needs. Users can request funds through services provided by software applications running on infrastructure systems in the form of loans, partial loans, mortgages, subsidies, and advance payments, among others. Users send requests to obtain access to financing to gain financial support, for example, through software provided services. For example, users may need money between their regular monthly paychecks because of unforeseen expenses, fluctuations of living expenses, and changes in social status, among other reasons.

### SUMMARY

The present disclosure involves systems, software, and computer-implemented methods for utilizing tools and techniques for providing a platform service in relation to received requests for advance payments. In some instances, the requests for advance payments can be requests for on-demand payments for performed work assignments from requestors, such as employees of a corporate entity. The platform service may be a cloud platform service that provides payment evaluation logic based on received requests, and that integrates with multiple systems running in a corporate platform environment.

In some instances, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One example method may include operations such as receiving, by a cloud platform service, a request from a user for an advance payment associated with a requested period of time, where the cloud platform service is integrated with a plurality of systems storing data for objects of an enterprise, where the requested period of time includes working days of the user, and where the user is identified as a objects of the enterprise in at least one of the plurality of systems. The method also includes in response to the received request, calculating an available balance amount that can be allocated to the user for the requested period of time, where calculating the available balance amount may include: determining data associated with the requested period of time to provide a basis for calculating the available balance amount, where the data is determined for performed work tasks and compensation to be monetized, and where the data is determined at least based on data stored at the at least one of the plurality of systems, where the data is associated with a current pay cycle including the requested period of time and one or more other pay cycles for the user; and calculating the available balance amount based on the determined data according to rules defined at a real time estimation engine defined at the cloud platform service, where the rules are for processing the determined data to calculate the available balance amount to comply with predefined criteria; and providing the calculated available balance amount at a user interface of the cloud platform service.

Similar operations and processes may be performed in a system comprising at least one processor and a memory communicatively coupled to the at least one processor where the memory stores instructions, that when executed, cause the at least one processor to perform the operations. Further, a non-transitory computer-readable medium storing instructions which, when executed, cause at least one processor to perform the operations may also be contemplated. In other words, while generally described as computer implemented software embodied on tangible, non-transitory media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example computer system architecture that can be used to execute implementations of the present disclosure.

FIG. 2 is a block diagram illustrating an example system for executing service requests at a platform integrated with enterprise systems in accordance with implementations of the present disclosure.

FIG. 3 is a flowchart for an example method for providing real time estimation services at a cloud platform in relation to requests from employees for monetarization of performed work tasks, compensation, and eligible benefits in accordance with implementations of the present disclosure.

FIG. 4 is a block diagram for an example system for providing real time estimation services at a cloud platform in relation to requests from employees for monetarization of performed work tasks, compensation, and eligible benefits in accordance with implementations of the present disclosure.

FIG. 5 is a flowchart for an example method for calculating an available balance based on stored and predicted data in accordance with implementations of the present disclosure.

FIG. 6 is a flowchart for an example method for requesting shift rescheduling in accordance with implementations of the present disclosure.

FIG. 7 is a flowchart for an example method for executing service request at a payment service integrated with enterprise systems in accordance with implementations of the present disclosure.

FIG. 8 is a flowchart for an example method for automatic approval of work hours of an employee of an enterprise in accordance with implementations of the present disclosure.

FIG. 9 is a flowchart for an example method for calculating an available balance for an employee of an enterprise in accordance with implementations of the present disclosure.

FIG. 10 is a schematic illustration of example computer systems that can be used to execute implementations of the present disclosure.

### DETAILED DESCRIPTION

The present disclosure describes various tools and techniques for providing a platform service related to receiving requests from requestors (e.g., employees of an enterprise) for potential advance payments. The platform service may be a cloud platform service that provides payment evaluation logic based on the received requests and that integrates with multiple systems running at a cloud platform environment of a corporation or entity providing work and compensation to workers associated with those requests.

The received requests at the platform service may be requests from employees of an enterprise, where those employees are interested in and are requesting advance and intermediate payment(s) in form of a no-interest loan or a loan with an interest rate below a threshold value. For example, a loan that can be requested as an advance payment may be a loan with an interest rate below a threshold value, for example, a loan having an interest rate that is below an average interest rate for private loans in a given place of business or residency of an employee. The advance payments may be an immediate compensation for already performed work tasks, bonus payment, and/or eligible benefits related to their engagement with the employer. For example, the advance payment may be requested outside of the normal (e.g. monthly, bi-weekly, among others) payroll cycle, which can allow for employees to support their financial needs that arise, or that are due, between regular paychecks. Some enterprises may schedule and execute payment just once a month, where, due to different external circumstances, an employee may be in financial need within a given month, and may have performed work and activities that correspond to a future paycheck, i.e., that could be monetized to a payment amount.

In some instances, to provide such payment evaluation and advance payment estimation, the platform service may be integrated with corporate systems set up to maintain data for employees and enterprise operations and obligations. That data may be used to identify whether a received request from an employee can be evaluated to determine an estimated amount for an advance payment, where that estimated amount can be transferred to the employee's account. When an amount is estimated, multiple factors or parameters may be taken into account. Those factors or parameters may be associated with the pay cycles of the employee or similar employees, allocated benefits (including monetary) for the employee, any garnishments associated with the employee, and over-time payments, among others. In some instances, an estimation of an advance payment may be based on data from the corporate systems. Thus, when determining an estimation of an allowable or available advance payment, the estimation can be provided so that the requestor is not paid more than what he or she had earned or accrued as a monetized payment when taking into consideration different factors that may affect the requestor's net income.

In some instances, future events in the pay cycle occurring after the requested payout can reduce the amount that will be paid out to an employee. For example, an employee who had worked for 10 hours at $10 per hour rate for 5 days may have earned $65 on the 5^{th} day of the pay cycle after taxes and deductions. In the present example, if the employee is evaluated to be eligible for an advance payment of $50 based on an estimation by the payment service, and if that employee was subject to a child support garnishment that comes into effect on the 6^{th} day of the pay cycle, then the amount that is the real eligible amount to be provided to the employee could be as low as only $20. In this case, an overpayment of $30 may be provided to the employee for which the employee may not be able to make up for during the current pay cycle (e.g., if the employee could not work for the rest of the pay cycle).

In some instances, the payment service may be implemented to serve requests of users, such as requestors, who send requests for advance payments based on what they have earned or accrued as a payable amount and which has not yet been paid to the requestor at the time of the request. The payment service may include logic to determine an available amount that can be allocated to a requestor associated with a request, where the request is associated with a requested period of time. The requested period of time may include working days of the user, who may be an employee at an enterprise or corporation. As the user can be identified as an employee of the enterprise in at least one of multiple corporate systems storing data for the enterprise, data related to work or tasks that are performed by the employee and that have not been paid or compensated may be identified, as well as awarded or accrued benefits available to the employee. For example, the systems may include human resource systems and administrative systems based on which performed work or tasks, or earned or accrued benefits, among others, are tracked. In some instances, to determine an estimated amount that can be provided as an advance payment, data stored in at least some of the different corporate systems may be relied upon for executing estimation logic that provides guarantees that overpayment to employees requesting advance payments is minimized or eliminated.

The corporate systems may include multiple systems, such as human capital management systems, corporate benefits and total rewards systems, payroll services, time and attendance systems, and schedule managers, among others. These systems may be instantiated to run different processes related to the operations of the enterprise, and may have different execution configurations. For example, there may be some systems that run in a delayed mode to populate updates of data into their storages, or that may delay synchronization between systems or data replication. Such systems do not track data in real time; however, the payment service may process received payment requests in real time, i.e. substantially without delay.

In some instances, when a requestor sends a request for advance payment of an amount based on work performed by and benefits assigned or available to the requestor, data related to the performance of the requestor can be determined. Such data may be at least partially present in the corporate systems storing data for the requestor. The payment service may use data stored at the corporate system, and may determine an amount of an earned salary or other type of compensation that the requestor can be paid out for the requested time period. The determined amount may be defined as an available balance for any requests from an employee, and may be determined, for example, based on accrued net salary for the requested period. Potential deductions or garnishments that may affect a final net payment of the employee can be taken into account during the estimation or evaluation. The payment service may implement logic for determining the available balance to prevent employees from being paid out more over the course of a pay cycle than an amount that they would be regularly paid if the normal payment at the end of the pay cycle were made, according to a regular payroll process. Thus, the payment service includes logic that takes data related to the requested period of time and other data related to the regular pay cycle that may affect a payment for the requested period into account. For example, an annual bonus payment for an employee may be taken into consideration when determining the available balance, and a portion of the bonus payment may be allocated for the requested period if that bonus is designated to be paid out to the employee. Further, garnishments associated with requestor and tracked in one of the corporate systems may also affect the net payment, even if they occur at a period of time outside the requested period. In doing so, garnishments may be taken into consideration for determining the requestor's available balance.

In some instances, an available balance may be determined based on simulation of a payroll process, where the simulation can be executed and/or initiated by a payment service. For example, the simulation may be performed at a payroll system of the enterprise employing a requestor. In some instances, the simulation may be performed based on data that is determined as a basis for performing a real time estimation of an acceptable amount to be allocated to the requestor. The determined data can be or include available data from one or more of the corporate systems, or may be predicted data that is calculated by the payment service in the absence of real (e.g., actually stored or tracked) data. The predicted data may be calculated based on various suitable algorithms, where those algorithms can be implemented to generate predicted data based on a set of current data for a current pay cycle associated with the request, as well as data associated with previous pay cycles. Using the current and historical data, predicted data sets can be generated and used in the calculation of the available balance.

In some instances, the payment service may calculate an available balance in such a way as to minimize a total possible overpayment resulting from underestimating or overestimating factors impacting payment of employees eligible for advance payment determination by the payment service.

In some instances, the platform service may be implemented to natively interact with the multiple systems running at a platform infrastructure of an enterprise (e.g. corporation) to execute the simulation, or may otherwise interface with the systems as needed to obtain the required information.

In some instances, payroll simulation may not be possible to be executed at the corporate systems, for example, due to access restrictions or technical incompatibilities between the payment service and the corporate systems. In those instances, an available balance amount can be predicted in response to a received request based on prediction models and data stored at the corporate systems that include both current data for a current pay cycle as well as historic data for previous pay cycles. Various suitable prediction algorithms can be implemented by the payment service to provide prediction functionality to determine an available balance amount based at least on some data stored at corporate system of the enterprise being an employer of the requestor. The determination of the available balance amount can be based also on other prediction parameters defined to improve accuracy of computations and to reduce risks of determining an available balance amount higher than a guaranteed accrued payment by the requestor.

In some instances, an estimation of an amount to be provided as an advance payment is performed at least in part based on data from corporate systems storing data for a requestor, such as where the requestor is an employee of an enterprise associated with the corporate system. These systems may be of different types, and may be configured to implement processes with different characteristics and requirements. Some of the systems may be developed according to technologies that are integrated internally with other corporate systems within the infrastructure environment of the enterprise, but that execute processes that do not facilitate real time data maintenance (e.g., where those systems have delayed data synchronization and/or replication, among others). Therefore, when an on-demand request is received at the platform service, data reliability for real time estimation may depend on an alignment between the platform service and the multiple systems storing data to support the execution of the platform service. In some instances, data may be missing as it is not populated in the systems at the time when a request is received. Alternatively, the data may exist, but that data may not be validated data. For example, worked hours may be identified in a system, but that data may not be approved, for example, by a manager of the employee. The data that can be used for performing the estimation for an advance payment may impose different challenges that can be addressed based on techniques described in relation to currently presented implementations.

In some instances, the platform service is instantiated at a cloud platform environment and is configured to communicate in a trusted manner with a customer environment where multiple systems are running. The multiple systems at the customer environment may be cloud systems and on-premise systems, or a combination of such systems. The landscape at the customer environment may be specifically configured to the processes that run in relation to the operations of the customer. Data may be stored, maintained, updated and populated between systems according to configured integration processes, where, due to technology specific to some or all of these systems, data may not be real time data at every single time point. The platform service can be natively integrated to communicate with the multiple systems at the customer environment and to authenticate in a secure manner. The platform service may invoke data at runtime and evaluate that data based on the implemented logic to predict real time data based on currently stored and observed data at the systems running at the customer environment.

The platform service may receive requests from end users that provide parameters for requesting compensations for performed work. The platform service may process such requests, verify the requestor's identity, and seamlessly transform the received request based on the implemented logic to acquire needed data from one or more of the systems at the customer environment. That data can then be processed according to implemented prediction model to determine predictable value of performed work and allocated benefits that can be eligibly monetized for the requestor. The platform service provides interfaces to communicate with different systems and applications and exchange data in fast and reliable manner.

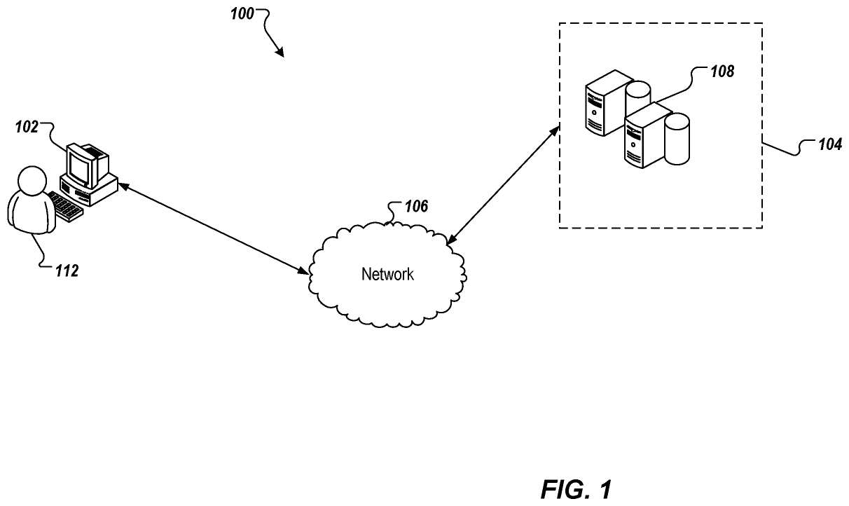

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processor(s), memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of server systems including, but not limited to a web server, an application server, a proxy server, a network server, and/or a server pool. In general, server systems accept requests for application services and provide such services to any number of client devices (e.g., the client device 102 over the network 106).

In accordance with implementations of the present disclosure, and as noted above, the server system 104 can host a platform implemented service to provide implemented logic to evaluate request for providing payment evaluation services in relation to request to determine acceptable amount to be paid as advance payments for already performed work an earned benefits at an enterprise. The payment evaluation service may implement logic for determining the acceptable eligible amount that corresponds to real acquired income that can be transferred as an intermittent payment. Thus, performed work activities and assigned benefits in different form and type from an employer to an employee that are tracked at enterprise systems may be monetized at real time and provided as finances to the requestor.

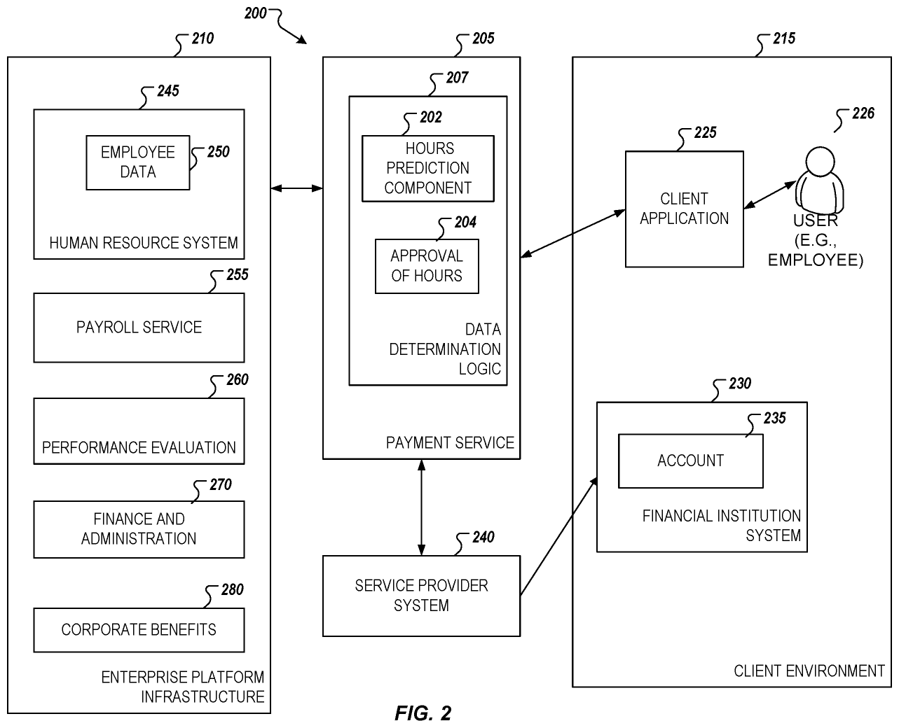

In some instances, the server system 104 may host a payment service, such as the services discussed in relation to FIGS. 2, 3, and 4. The payment service may be a platform service for evaluation of requests from employees for advance compensation for already performed duties for an employer, where the payment service can be natively integrated with corporate systems of an enterprise to provide real time evaluation of data and serve request on demand.

FIG. 2 is a block diagram illustrating an example system 200 for executing service requests at a platform integrated with enterprise systems in accordance with implementations of the present disclosure. System 200 includes a payment service 205 that can be implemented as a cloud service running on a cloud platform to provide services to request in relation to an enterprise platform infrastructure 210 where multiple systems are running. The received request may be associated with a specific time period to correspond to the advance payment, for example, 3 days, 5 days, and 2 weeks, as well as other suitable periods. Different configurations of defining the request may be supported. The payment service 205 is integrated with the systems running at the enterprise platform infrastructure 210. The payment service 205 can perform seamless data extraction and real time data evaluations to provide services to end users.

In some instances, a client environment 215 is set up, in which a client application 225 is running and is in communication with a user 226. The user 226 may be an employee of an enterprise that is related to the enterprise platform infrastructure 210 and the executed systems thereof. For example, the enterprise may be a large corporation which has implemented and configured multiple systems for storing corporate data and for executing processes. The configured corporate system may include cloud-based systems and on-premise systems to support enterprise execution and administration.

The enterprise platform infrastructure 210 may be used for systems in different corporate areas, and can provide different types of services. The systems may be related to the execution of the enterprise as a corporate entity. For example, the services may be related to performing transactions, defining rules for operations, executions, analysis, etc. The enterprise may store data in special database systems or specific applications that are configured to execute particular enterprise processes. The enterprise systems may store data in the form of data object related to employees and other organizational entities, or any other suitable form.

The enterprise platform infrastructure 210 may provide software and hardware resources to execute platform systems, where the platform systems include, for example, human resource system 245, payroll services 255, performance evaluation services 260, finance and administration services 270, and corporate benefit services 280, among others. In the present example, the human resource system 245 may include a subsystem storing data for time and attendance of employees, workers, consultants, etc. These systems may store data related to some or all employees. For an employee, and using data from the human resource system 245 and the included employee data 250, a determination can be made as to whether or when the employee had started performing a certain job, how long he has been in the corporation, his role, his education, his position, and a type of an employee he is (e.g., full time, part time, limited part time, etc.), among other information. Further details may also be stored in the human resource system 245.

In some instances, an enterprise may store data related to their corporate benefits policy in the corporate benefits system 280. Such corporate benefits systems 280 may include different type of social benefits, including vacation time allocation, extra time payment policy, vouchers for food, allocated money for subscriptions (e.g., sports, technology, health), health benefits, corporate discounts, and equity policies, as well as other suitable information. The corresponding corporate benefits stored in or identified by the corporate benefits system 280 may be evaluated to determine a corresponding monetary value. Some or all of the benefits defined at the corporate benefits system 280 and associated with different employees based on their role, profile, and other characteristics may be used by the payment service 205, in part, to determine an eligible amount for advance payment to an employee. For example, vacation days (e.g., up to a given maximum threshold, if defined) may be monetized and pre-paid to an employee upon request. Other eligible benefits and their corresponding monetization rules may be configured at the payment service 205.

Further, the payroll services 255 implemented and running at the enterprise platform infrastructure 210 may provide logic for execution processes related to performing payments and controlling activities. The payroll services 255 may, for example, be configured to initiate payment execution to different employees on different dates or at regular intervals according to predetermined rules. For example, all full-time employees may be associated with a rule to execute payment transactions on every first day of the first working week that is a working day of the next month subsequent to the month of performed work. In another example, employees on temporary contracts may be associated with a rule to execute payment every two weeks. Similar and different other possible configurations can be defined and applied. To reduce a load of transaction executions, such payment transfers and instructions may be spread over time to improve system performance and load balance transactions, such as where a company or enterprise has hundreds and thousands of employees, to whom regular transactions associated with those employees' payments must be performed.

In some instances, there are one or more systems at the enterprise platform infrastructure 210 that store data for the employees in the form of objects that are defined as employee data. Such employee data can data related to the performed work tasks, the eligible benefits, employee identification data, and other employee profile data for the enterprise. That data may not only be the employee data 250, but also data stored at other systems that can be mapped to a single user, and may include a subset of data entries acquired at or from multiple systems. In some instances, at least a portion of the subset of data entries may be obtained on-the-fly or in response to request, while in others, data may be acquired from those systems and stored within the employee data 250 at the enterprise platform.

In some instances, some of the systems running at the enterprise platform infrastructure 210 may be systems configured to replicate data, and landscape synchronize data in delayed form. These systems may not execute all of their processes at runtime, and instead may execute at defined and/or on dynamic schedules. Therefore, some of the systems have periods of time when the data that they store is not cohesive, and does not reflect the real current snapshot of activities and assets assigned to the employees.

In some instances, user 226, who is an employee of the enterprise associated with the systems running at the enterprise platform infrastructure 210, sends a request to the payment service 205 to request advance payments for performed work duties for which the user has not been compensated with payment or in another form (e.g. vouchers, virtual currencies, etc.). When the request is received at the payment service 205, the payment service 205 evaluates the request and provides an estimation of an available balance amount, where the available balance amount can be provided as an advance payment or a loan. The estimated available balance amount can be determined to cover corresponding work (and/or allocated benefits, among others) that has already been performed by the user 226.

In some instances, based on whether the enterprise platform infrastructure 210 supports simulation or not, the evaluation of the data can be performed in a simulation framework or in prediction framework. In some instances, to perform a simulation, the data and the configurations at the payroll systems have to be accessed. In response to accessing the data, the data can be fed into a simulation framework to perform a shadow-payroll execution. In some instances, by executing the shadow-payroll based on the data and configurations gathered from the payroll systems, new data can be generated that may be stored separately and externally to the payroll system. In some instances, the result of the simulation can be used to determine an available amount to be allocated to the requestor. If the systems part of the enterprise platform infrastructure 210 support simulation, data from these systems that is related to the received requests and/or the performed evaluation can be loaded into a simulation framework, where the simulation framework can automatically run a payroll simulation process to determine an available balance that can be allocated to a requestor. The payment service 205 can support execution of simulations by accessing and modifying data at the payroll service system 255 that is associated with the execution of a payroll process at the enterprise platform infrastructure 210.

If some of the systems part of the enterprise platform infrastructure 210 do not support simulation execution, data from those relevant systems can be loaded in a prediction framework, where the prediction framework processes the data based on rules defined at a prediction model. Multiple prediction models may be defined and used to provide estimations of an available balance amount that can be provided as advance payments to a requestor.

The payment service 205 can be natively integrated with the systems running at the enterprise platform infrastructure 210 to request and receive data in relation to employees of the enterprise. If the payment service 205 is integrated with the systems, the payment service 205 can access data in real time and process the data to provide real time services to requestors, such as employees who request advance payments from their employer.

The payment service 205 identifies the requestor based on the received request. For example, the user may use authorized credentials (e.g., a username and password) to authenticate and identify themselves as a legitimate user, thereby allowing them to request services through the payment service 205. The payment service 205 determines whether the user is an employee, for example, by acquiring relevant data from the systems running at the enterprise platform infrastructure 210. In some instances, the payment service 205 may determine the identity of the requestor by verification performed through communication with the human resource system 245 including the employee data 250. When the user 226 is identified as an employee, the payment service 205 may acquire acquiring data from at least one of the plurality of systems related to the requestor. The acquired data can, for example, include data defining performed work tasks, associated compensation, and eligible benefits to be monetized that have not yet been paid to the user. For example, the data may define the number of hours spent at the workplace, the number of hours spent at a client's facility, or a type of an assignment, among others. The eligible benefits may include bonuses that are allocated by the employer to the employee, as well as accrued paid time off, sick days, and/or vacation days, among others. The eligible benefits may be evaluated and monetized based on received requests and allocation according to configured system rules.

In some instances, some of the systems at the enterprise platform infrastructure 210 may not include data relevant for evaluating a request for an advance payment received from a requestor. For example, a system, such as the performance evaluation 260 system or other may store data associated with current working hours performed by an employee. In some cases, even where there is data available within the system, such data may not be approved or otherwise finalized, and may require further verification of the data entries before continuing with or applying the data to particular calculations. In some cases, some of the data may be missing or otherwise unavailable. The payment service 205 may include data determination logic 207 that include implemented algorithms and operations to predict data when data is unavailable and/or incomplete, and/or to provide approval of non-approved data, if such approval is missing.

In some instances, when tracked data for performed work by an employee is missing, the payment service 205 may include logic to predict working hours so that the incomplete data can still be used to provide and generate an estimation of the available balance amount that can be provided to a requestor. For example, the logic of performing a prediction of working hours, when those hours are not tracked or are otherwise incomplete, may be provided by an hours prediction component 202 included in a data determination logic 207 implemented as part of the payment service 205. For example, the hours prediction component 202 can be configured to predict hours using any suitable technique, including through automatic estimation of working hours or through extrapolation techniques as applied to other or historical information.

In some instances, a shadowing time recording can be configured and/or used for one or more users. For example, an employee may perform time recording on a paper maintained at their desk or personal space, or through a word processing or spreadsheet document, with the information on that recording later being transferred to the time recording system. This transfer can cause a delay in the reproduction of the worked hours at the system, which may itself coincide or overlap with a request for advance payment. In such cases, the data associated with the employee for the relevant time period(s) being requested may be missing, unavailable, or incomplete. The payment service 205 may implement an interface for interaction with requestors (e.g., employees) to record their time in a dedicated timesheet as a manual entry outside of the process flow for tracking and recording time. For example, employers may choose to use such an input as their single source of truth for time recording. Alternatively, such an input may be used solely for purposes of predicting an employee's available balance.

In some instances, a shadow time recording system may be maintained by the payment service 205. The time recorded in this shadow time recording system will be considered similar to other time recording systems (at the enterprise platform infrastructure 210) with which the payment service 205 is integrated. In some instances, and in an attempt to improve security by avoiding calculating based on fraudulent data, the payment service 205 may implement additional measures to prevent unwanted overpayment. In some instances, when a time recording is input by a requestor, the payment service 205 may perform comparison of the entered worked hours with those hours that were recorded during previous months. In some instances, predictions for expected working hours of an employee may be provided and used to limit an estimation of an available balance based on these predictions. For example, predictions based on historic data for previous working hours from past pay cycles may be used to lower the estimation of an available balance. If the hours recorded through a directly input time record in the current pay cycle are higher than and/or exceed a prediction made based on historic data, then the historic data may be used to lower an available balance estimation associated with or offered as an advance payment. In the context of this example, a threshold value relative to a prediction of expected working hours may be configured to limit an available balance estimation when that estimation is based on manually input time records that are not or have not been verified and/or approved at a system of the enterprise platform infrastructure 210.

In some instances, when an employee has entered working hours performed for a given time period, but the recorded hours have not yet been approved by a designated user or process, an estimation of the performed hours can be done based on prediction techniques according to historical data. For example, if an employee has been recording five (5) hours of daily work consistently over the last few months, and he or she suddenly starts recording eight (8) daily hours of work, the system may initially limit the available balance to an amount based on a six (6) hour daily work schedule. In case this shift corresponds to an increase in the contractually agreed working hours, the predictions can trail the actual working hours, and the available balance can be adjusted over time and in response to later requests.

In some instances, the payment service 205 may use the data recorded in the systems at the enterprise platform infrastructure 210 to adjust the predictions, including based on actual changes made to the employee's contract. For example, a contractual increase in working time can be recorded in the human resource system 245 and/or payroll service 255, and can be taken into account by the shadow time recording system during later calculations and estimates.

In other instances, when data related to performed work is missing, extrapolation can be performed to predict the worked hours. In some instances, working hours can be considered as a multi-layered time series including granular recordings, for example, daily, hourly, or any other suitable period. The working hour recording can be pay-cycle-based recordings. For example, the daily recordings may be defined as a tuple (t₁,tₙ), where i=1, . . . , n represents the days in a pay cycle. The pay-cycle-based recordings can be defined as a series of numbers cᵢ^{j} where i represents a day in the pay cycle and j represents a pay cycle. The sum of (approved) hours recorded in pay cycle j up to day i can be defined as cᵢ^{j}. For the last k pay cycles for a given employee on day i of the current pay cycle, a data vector of k values−Cᵢ=(cᵢ¹, . . . , cᵢ^{k})=c/), can be considered to determine an estimation of working hours for a particular employee. To estimate the employee's current working hours for period k+1 (i.e., cᵢ^{k+1}), one of the following methods may be used:
Classical time series forecasting, for example, ARIMA, SARIMA, and other suitable options;
Exponential Smoothing;
Deep learning using neural networks; and
Monte-Carlo Simulation, among others.

An extrapolation method to determine a predicted number of worked hours for a current day or period of time can be configured based on employer's preferences or other technical considerations associated with the resources used for execution of an extrapolation process. Algorithms can be implemented in relation to such extrapolation methods that can take specific information, which can be provided by an HR system or other administrative system storing data for the employee into account. Such information for the employee can be evaluated when evaluating work performed by the employee to determine an estimated amount that can be loaned to the employee as an advance payment. For example, such data can be evaluated to determine whether there are certain events or changes that have recorded for the employee that can reflect on the evaluation of the estimated amount to be provided as an advance payment, for example, events related to a job or contractual change can be taken into consideration to determine a risk level associated with the employee when providing an advance payment based on performed work and performance. In some instances, rather than using particular implementations of such estimation algorithms, one or more algorithms can be combined to provide more accurate results. In addition, by combining multiple implementations, the result of the estimated advanced payment amount may be provided in a manner that reduces overpayment from the employer to the employees who may request advanced payment. For example, deep neural networks can be trained to predict the working hours based on data from the full (or relevant and/or related subset of the) population of employees, and by using working hours and human resource events. In some cases the human resource events can include contractual changes, promotions to a new position, demotions to a lower level position, and changes to the working hours, and past overpayments, among other example events. In addition, multiple prediction approaches can be run in parallel using a Monte-Carlo method providing a range of possible outcome scenarios that allows customers to make informed trade-offs between a risk of overpayment and maximizing available balances for employees. For instance, based on the outcome scenarios computed for each employee making a request, employers may decide to go for a conservative bottom-quartile estimation (only 25% of predicted outcomes lower than chosen prediction) or a more aggressive top quartile estimation of predicted values (75% of predicted outcomes lower than chosen prediction) when determining an estimation for a an advance payment.

The payment service 205 identifies the user 226 based on the received request received through a client application 225 used by the user 226. For example, the user 226 may use his handheld device executing the client application 225, which he uses to monitor his work activities and paychecks. The client application 225, when used to request advance payment, sends a data request to the payment service 205 providing user-identifiable information that can be used to verify and validate that the request is coming from an authorized user with the capability (or authorization) to request such payment services 205.

In some instances, when a request is evaluated to determine available balance, the evaluation may include evaluation of data associated with eligible benefits that are allocated to the requestor by their employer. In some instances, the eligible benefits may include different forms of corporate benefits that can be offered and assigned to employees based on their performance, or as part of their compensation or employment. Eligible benefits may be only a part of the benefits provided to an employee. Employees are usually provided with vacation days per year, month, or other period of time, as part of their employment, where a part of the vacation days (or the whole time) can be considered as eligible benefit that can be monetized, for example, depending on the time point of the request within the year, month, or other as defined. For example, an employee may be provided with 30 days of paid vacation for a year, providing 2.5 days of vacation every month if taken consistently. However, an employer may have configured rules indicating that even if the employee has not taken all of his days of paid vacation, the employee would be reimbursed for unused vacation days only up to a certain limit (e.g., a max of 20 days per year). In this context, if an employee requests advance payment for a current period of time which has not been already paid, then a number of days corresponding to the worked days and based on the maximum vacation days allowed for reimbursement may be monetized or included in the calculation. In particular, if the employee requests advance payment in the middle of a certain month, the limit of vacation days for which the employee can receive reimbursement (e.g., received monetary equivalent to these days) can be equal to 20 divided by 12 (i.e., 1.67), which is then divided by 2 to represent that the period is half of a month, thereby equaling 0.83 days. That number of days can then be monetized based on the daily salary payment for the employee or an estimation of his daily payment according to evaluation of data stored for his performance and attendance to work activities and received payments.

In some instances, the payment service 205 determines an available balance by evaluating the acquired data from one or more of the systems running at the enterprise platform infrastructure. The number of systems requested for data and that provide data in response to the request may vary and can depend on the requestor and the type of data stored for the requestor at the various systems. The data can be acquired at real time during the execution of the payment service 205. In some instances, access to systems from which the data is acquired may be associated with slower access, and therefore data replication and/or caching can be configured for such systems to improve efficiency and operations. As some of the systems at the enterprise platform infrastructure 210 may have data that does not correspond to current actual work performance/status of the employee, the payment service 205 may use a predictive model to determine an estimation of what has been earned by the employee, as well as what an eligible acceptable amount to be provided to the requestor may be. The predictive model may be implemented in the logic of the payment service 205, and may encode, include, or use processing rules defined in relation to different properties of the data acquired from the various systems. For example, for a system that acknowledges employee attendance, the data for the attendance may be populated every day at 5 PM. However, the employee may request for advance payment at 4 PM of a particular day where that employee has attended or continues to attend work and perform their regular duties. The prediction model may be configured to acquire data from the attendance system, and, even though the current day may not be indicated as a day where the employee had worked as the request is processed after 4 PM but before 5 PM, can still determine that the employee may be provided with an advance payment that includes the current day based on a generated prediction that itself is based on data available from planned work schedules and/or other data that allows conclusions and predictions to be drawn/generated for the employee's work patterns and expected attendance and work on the current day. The prediction model may be used, for example, to predict performed work, but also may be used to predict approved work after the work has been input as completed. Further, the prediction model may predict an expected compensation for the performed work, eligible benefits allocated to the requestors and/or other compensations that are allocated for the requestor in accordance with configurations at the systems storing data for the employee. For example, the data used by the prediction model may data associated with employee time entries, approved employee time entries after an internal review process, and/or allocated compensation benefits, such as bonuses and commodities, among other suitable and relevant data.

In some instances, the prediction may take into account how often the employee takes vacation or personal leaves, whether the employee has been on a sick leave the previous day, or whether the employee has requested vacation that has not yet been approved for the current day or a future time within the pay period, as well as other considerations. The prediction model can be configured based on requirements specific to the enterprise and any specific system rules configured for the systems running at the enterprise platform infrastructure. In other instances, default considerations and configurations may be applied.

After the payment service 205 determines an acceptable available balance amount to be provided as an advance payment to the requestor, the payment service 205 may communicate that amount with the user 226 via the client application 225. Further, the payment service 205 may request execution of a transaction payment to the user 226 through a service provider system 240 in response to the user 226 accepting the advance payment. Service provider system 240 may be a trusted system for the payment service 205 and the enterprise. The service provider system 240 may receive an instruction from the payment service 205 identifying the entity or person to be provided with the advance payment. The instruction may identify the user with legal credentials (e.g., legal name, social security number, etc.), and may provide details for executing a transaction to the user's associated account (e.g., a bank or other financial account). The service provider system 240 may instruct a financial institution, such as a bank associated with the employer, to send an advance payment to an account 235 associated with or defined for the user 226 (e.g., at a financial institution system 230).

As the payment service 205 can interact with some or all of the systems at or associated with the enterprise platform infrastructure, the payment service 205 may also be configured to support requests from employees and provide options for rescheduling of work activities that may result in a change in the determined available balance that is estimated and can be paid. For example, the payment service 205 may include logic to evaluate the work schedules (e.g., stored at one or more of the systems) and suggest reallocation of shifts for some employees to increase the number of worked hours for an employee within a closer time frame in the future. In doing so, the solution may allow an employee to increase (or attempt to increase) their future earnings during the pay period or cycle. This may be important in situations where an employee needs to make an urgent payment or cover an unexpected short-term cost, and, upon review, that employee's remaining available wages will not cover those upcoming expenses.

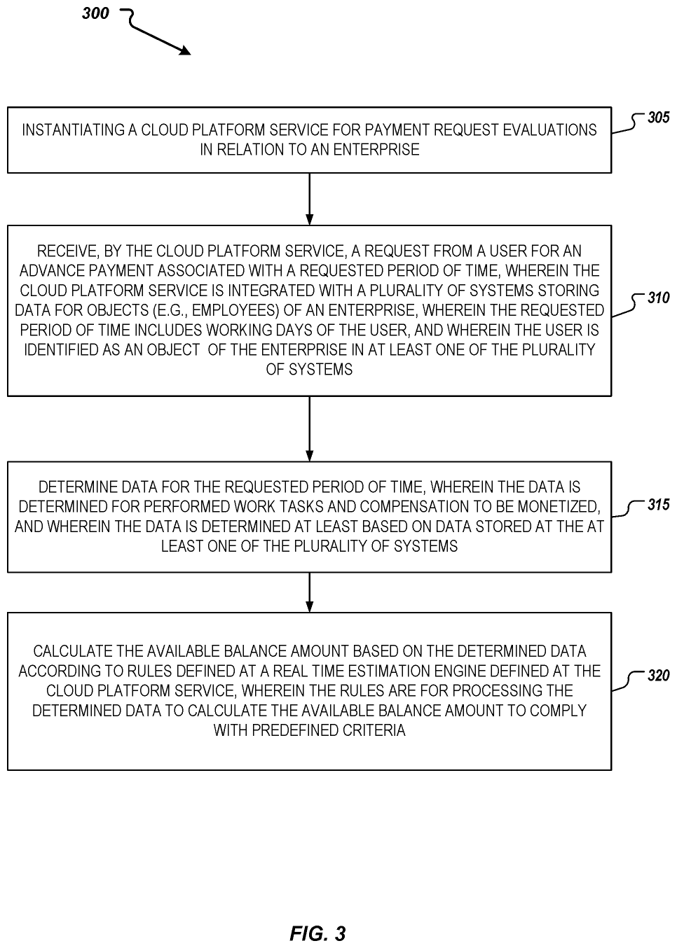

FIG. 3 is a flowchart for an example method 300 for providing real time estimation services at a platform receiving requests from employees for monetarization of performed work tasks, compensation, and eligible benefits in accordance with implementations of the present disclosure. The method 300 may be executed at the example system 200 and the provided environment discussed in relation to FIG. 2.

At 305, a cloud platform service is instantiated at a platform infrastructure environment. The cloud platform service may be configured to run at a cloud infrastructure together with other provided cloud service. The platform service is configured to access a plurality of platform systems from an enterprise integrated environment. For example, the platform systems may include the systems running at the enterprise platform infrastructure 210 as described in FIG. 2. The platform service is instantiated, and can receive requests from users, such as employees of an enterprise associated with the platform systems.

At 310, a request for advance payment is received by the cloud platform service for payment request evaluations. The requestor is identified as an object of the enterprise. In some instances, the request is received from a requestor who is an employee of an enterprise. The request is associated with a requested period of time that includes working days of the requestor, where the requested period is or may be associated with performed work tasks and compensation that have not yet been monetized and paid to the requestor. In some instances, the compensation may include a salary of the requestor, a bonus of the requestor, and eligible benefits assigned to the requestor, among other types of benefits that can be provided by an enterprise to an employee.

In some instances, eligibility for work-related payment can be determined based on pay cycles. In those cases, employees can request advance payment going back to a previous pay-check. In some more instances, other eligible benefits provided to employees may be evaluated on a yearly basis, e.g., paid time off, or longer period for personal time, sabbatical time, and monetizable contribution according to a health or insurance plan, among other examples of eligible benefits allocated to employees. In some instances, different time frames can be defined for some or all of the different benefits. For example, time frames may be separately defined for each eligibility type of a benefit and/or may be considered based on individual consideration for limiting pay out for a given benefit. For example, advanced payment based on accrued paid time off can be paid out up to a predefined maximum amount of time (e.g., days or hours).

In some instances, depending on employers' and employees' preferences, various types of compensation can be included in the calculation of available balance that may be applied separately for the different types or as a whole. For example, when an employee makes a request for an advance payment, the employee may specify the amount requested and there may be no specific limitations for a time frame for eligibility for receiving advance payment for allocated compensations. In some instances, request can be set up by default to be calculated for the whole period that has passed since the latest pay-check. In some more instances, employees can also specify which contribution to be used when evaluated for an advance payment. For example, an employee may configure to get 50% of a requested amount from worked hours and 50% from paid time off accrued, when such options for payment based on worked hours and paid time off are available and enabled for that employee.

For example, a request may come in during the particular pay cycle of the enterprise, where some work has been performed, and some compensation or benefit has been earned, but no payment has yet been made. The platform service is integrated with a plurality of systems storing employee data for the enterprise. The systems from the enterprise environment include, for example, human resource systems storing employee data, payroll systems, time management system, administration and finance systems, talent and acquisition systems, and corporate benefits systems, among others.

Based on the received request for advance payment, a requestor is identified and it may be determined whether the requestor is an employee of the enterprise associated with the integrated plurality of systems with the platform service. For example, the requestor can be determined to be an employee based on provided credentials or identification when accessing the platform service and sending the request that is received at 310. In at least one of the plurality of systems integrated with the platform service, the requestor can be identified as an employee of the enterprise.

In some instances, the request is received from an employee of the enterprise in association with a request to receive an advance payment for work performed for the particular time period. For example, the particular time period can include a portion of the current pay cycle, which can be defined as a number of days, weeks, months, or any other suitable time period definition. The requested particular time period may be a period where the requestor has not yet received his full compensation (e.g., a monthly salary payment, benefits, and bonuses, among others). For instance, the request may be sent by the employee before the current pay cycle has finished. For example, employees sometimes receive their salaries for a given month at a first working day of a subsequent month. For example, a salary for October work may be received on first working day of November. Therefore, there are periods of time in a given month or other pay period where work is performed, but payment has not yet been received. Payment for such a period may be requested by an employee at the platform service, as discussed at 310. The request for payment can be evaluated to determine an available balance that can be provided as an advance payment. The evaluation of the requests can include an evaluation of data defining activities performed by the employee since his latest payment and other data about eligible benefits and/or compensations allocated to the employee. In some instances, some or all of the activities performed and other information may be estimated based on prior entries and/or information about historical performance by the employee.

At 315, data for the requested period of time is determined. The data can be associated with performed work tasks, earned and/or eligible compensation, and earned and/or eligible benefits that can be monetized. The data associated with the request (and the requested period and employee) can be determined based at least on data stored at least at one of the plurality of systems storing data for employees. The data that is determined is associated with a current pay cycle including the requested period of time and one or more other pay cycles for the employee.

In some instances, a first system of the plurality of systems can be a system with a delayed process execution, such as where process execution is not performed at runtime and/or real-time. For example, the first system may execute a first process associated with tracking data for the employees of the enterprise in a discrete delayed manner at fixed iterations (e.g., every day at 5 PM attendance for the day is calculated, finalized, and stored in-system). For example, a tracking system different from the first system can record performed work based on logging of data entries for tasks performed through the day based on employees' entries (e.g., using a card, chip, or manual entry in a software system, among others). In some instances and systems, the recorded entries can be propagated and synchronized with other systems, such as the first system, only once per day, or at several intervals throughout the day. In those instances and systems, there may be moments of time before a synchronization or an update of the first system occurs where the actual data associated with the tracked work that is stored in the tracking system is not populated in the first system, and the first system may include data that is currently old due to the delayed process execution. The data in these cases would be updated after execution of a next iteration of a process at the system, where the data is synchronized and/or updated to populate the first system with data corresponding to the received and stored input at other systems.

In some instances, if data is acquired by the platform service from the first system to determine data associated with a received request and a requested period of time, the acquired data may not be actual real time data. In those instances, data discrepancies may arise at the platform service and elsewhere due to delayed processes executed at the first system. In some instances, the acquired data from the first system may be data acquired between two consecutive iterative executions of a first process at the first system where changes in other system have not yet been propagated. In some instances, the first process may be a replication process executed in iterations with fixed time intervals, or the first process may be a synchronization process between multiple systems and data fields within the first systems. In some other instances, the first process may be a transformation process that is running in delayed mode and not runtime. In such instances, a change from one system is propagated into the first system when a next execution of the first process is performed, and not as a result of every new entry of data or every change in the database. The data at the first system where such processes are implemented may not be current at certain time points and intervals and cannot be properly relied on when performing real time evaluations based on such data.

In some instances, data from the first systems can be acquired and can be used to provide a time estimation of the data in the first system, and to determine whether there are discrepancies that can be covered through performing prediction of the real data. Such prediction may be performed based on evaluation of historic data stored in relation to the requestor at one or more of the systems associated with the enterprise.

At 320, an available balance amount is calculated based on the determined data and according to rules defined at the platform service. The available balance amount is determined to be allocated to the requestor as an advance payment. The available balance amount is provided at runtime of the platform service and is based on a real time estimation of the compensation for performed work of the requestor and eligible benefits for allocating money to the requestor. The provided real time estimation is determined based on the received request and the requestor. The performed work, such as work tasks, may be tracked at different systems and in different format. For example, performed work may be tracked as tasks, projects, assignments, and daily routines, or in any other suitable manner. These tracked work tasks may be also associated with a performance rate, a number of hours for performing the work tasks, or a cost of the work (fixed or hourly determined payment or salary allocated).

The available balance amount calculated at 320 may be computed based on a prediction analysis according to a prediction model defined at the platform service. The prediction model is defined at the platform service to provide predictions of real time data and thus to compensate for non-current data stored at any one of the systems from which data is acquired. In some instances, the prediction model may take into consideration future events and likely process outcomes that may impact an employee's eligible compensation as an advance payment for the requested period of the pay cycle. Based on such a prediction, an acceptable amount for allocating to the requestor is determined at runtime.

In some instances, the predictive model is defined to provide a prediction of data changes related to the data from the first system to provide a real time estimation based on the combination of non-current data and current data. Real time estimation includes computing a prediction value of a monetized amount (e.g., an available balance amount) corresponding to the performed work tasks and the eligible benefits based on the processing rules.

In some instance, based on determining the acceptable available balance amount, the platform service provides an instruction to a financial service associated with the plurality of systems and the enterprise. The provided instruction relates to executing a transaction according to the determined available balance amount for the requestor. The financial service is configured to execute financial transactions for the enterprise. In some instances, the determined amount may be transferred according to the logic of the financial service to a bank account, prepaid card, or payroll card of the requestor, or may be provided in other monetary type, such as a check, voucher, or deposit. Other forms of executing a transfer of money from the enterprise to the requestor may be also appreciated as covered by the described transaction execution.

In some instances, the platform service is integrated to interact with multiple corporate systems storing employee performance data and other data required to provide advance payment estimation for requests. The platform service performs the advance payment estimation with improved processing as data exchange between systems can be performed with fewer resources, fewer interactions, and directed to data that is only relevant for the estimation of the particular request. As the platform service implements a prediction model that can automatically evaluate data and provide an estimation of an available balance based on tracked work at the multiple systems, the platform service performance is faster, more accurate, more reliable, and can ensure a higher level of compliance with various regulatory requirements, including, but not limited to, tax law, wage/hour regulations, financial regulations, and consumer protection regulation. The platform service may be configured to interact with client applications of employees to seamlessly provide secure and reliable communication and exchange of data between systems and applications running at different infrastructure environment with different security levels. The platform service provides secure data exchange between systems running at an employee infrastructure, such as employee mobile devices, financial institution infrastructures, enterprise infrastructure, among other. In some instances, the financial institution infrastructures may include bank systems that store accounts of the employees and the employer (enterprise).

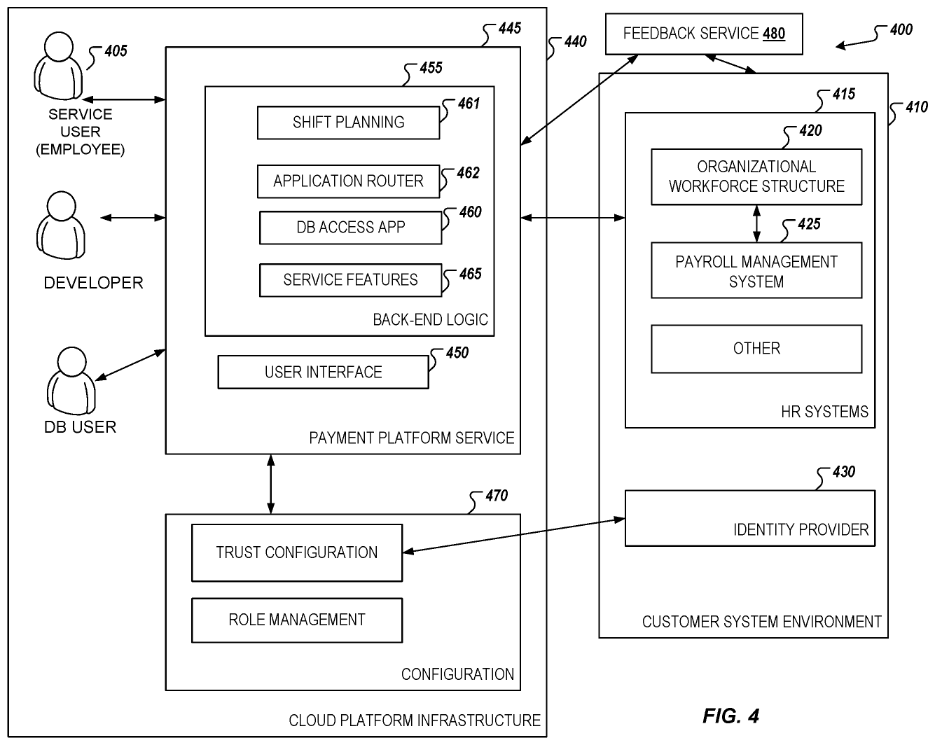

FIG. 4 is a block diagram for an example system 400 for providing available balance estimation services for requests from employees for monetarization of performed work tasks, compensation, and eligible benefits in accordance with implementations of the present disclosure.

A payment platform service 445 runs on a cloud platform infrastructure 440. The payment platform service 445 may be similar to the payment service 205 described in FIG. 2, or the platform service discussed above in FIG. 3. The payment platform service 445 is a cloud service that provides a user interface 450 that may be exposed to requestor, such as a service user 405. When a request from a user, such as the service user 405, is received, an application router 462 may evaluate the request and determine properties of the request and the requestor. The application router 462 may identify the requestor and perform verification and validation for configured enterprises and enterprise platform systems integrated with the payment platform service 445.

The application router 462 uses configuration 470 set up at the cloud platform infrastructure 440 to determine the enterprise identity. The configuration 470 is maintained to store trusted configurations between the payment platform service 445 and a customer systems environment 410. The customer system environment 410 is an environment of an enterprise where different systems are running, and may be a part of the cloud platform infrastructure 440. In some instances, the customer system environment 410 may be similar to the enterprise platform infrastructure 210 of FIG. 2.

The customer system environment 410 includes an identity provider 430 component that can be used to perform identity authentication of requests received from payment platform services such as the payment platform service 445. The payment platform service 445 may be configured as a trusted entity for interaction with systems from the customer system environment 410. Such a configuration may include a predefined list of users authorized to initiate interaction with the system from the customer system environment 410 by sending requests to the payment platform service 445. Therefore, the payment platform service 445 may verify identity of requests and provide corresponding actions based on the verification—to either perform payment estimation or to decline the request.

The service user 405 may be an employee of an enterprise that requests advance payment for performed work activities and eligible allocated benefits by the employer. The user 405 may request for such advance payment outside of the normal pay cycle to support his financial needs. The advance payment may be determined as a payment that correspond to performed duties, and thus may be considered a non-risky payment in the form of a fully guaranteed loan with no or low interest rate that can be transferred from a bank account of a 3rd party funding provider to a bank account of the employee.

The payment platform service 445 includes a database access application 460 and service features 465 as part a back-end 455 logic implemented at the service 445. The database access application 460 provides functionality to request and acquire data from database storages and systems at the customer system environment 410. The service features component 465 includes logic to evaluate acquired data and to provide real time estimate for an acceptable amount payable to an employee for performed work tasks and based on allocated benefits for a time period requested. The service features 465 may include a defined prediction model to evaluate acquired data from the systems and transform it into a prediction during runtime. The prediction is performed to evaluate and estimate differences between tracked and actual data at some or all of the systems at the customer system environment 410. Such differences may be due, for example, to delayed process execution, data transferring, synchronization gaps, replication delays, or the like.

The payment platform service 445 interacts with systems at the customer system environment 410 in a similar (or different) manner as the payment service 205 interacts with systems at the enterprise platform infrastructure 210. In response to identifying the service user 405 requests services at the payment platform service 445, the service 445 may determine that the service user 405 is an employee. The request may be received for advance payment at a time point between two consecutive regular payment executions from the employer to the requestor. The request may be associated with a specific period to correspond to the advance payment, for example, three (3) days, five (5) days, or two (2) weeks, among others. Different configurations of defining the request may be supported.

The requestor may be identified as an employee based on identifying a data record stored at a system at the customer system environment corresponding the identity of the service user 405. The payment platform service 445 may acquire data from at least one of the systems running at the customer system environment in response to receiving the request. The customer system environment 410 includes human resource (HR) systems 415, which can include an organization workforce structure 420 system and a payroll management system 425, among other components or systems. The organization workforce structure 420 system and the payroll management system 425 store data related to work performed by employees, data about the employees, their corporate role, and performance, executed payments for their performances, data about deductions and/or garnishments, and information about working patterns, worked hours, and shifts, among other suitable information. Further, the systems may also include data related to previous requests for advance payment or other approvals for receiving financial support. The HR systems 415 include data that defines performed work tasks, compensation, and eligible benefits that can be evaluated to determine an estimate of the performed work and eligible benefits, which can then be used to determine an available balance as monetized estimate for an advance payment amount that can be transferred to the requestor.

The payment platform service 445 includes a shift planning feature 461 as part of a back-end logic 455 implemented at the service 445. The payment platform service 445 uses shift planning data from employers' time and attendance system as well as information on employees' experience and financial status to provide options for modification of shifts to employees who are experiencing financial gaps and need advance payments. The shift planning feature 416 can be triggered proactively by the service user 405, being an employee seeking to increase their income. The shift planning feature 461 includes logic to suggest additional shifts, where such shifts need to match an employee's profile and they need to be available for them. The payment platform service 445 obtains data about the employee's profile from the HR systems 415 by reading the employee's job profile and seniority. Further, the payment platform service 445 obtains information about the shifts an employee has previously held within the company. Based on the obtained information, the shift planning feature 416 includes logic to filter shifts from employers' shift planning schedules, including those that are free as well as the ones that have already been allocated. If free shifts corresponding to these filters are available, the shift planning feature 416 suggests these shifts to the user/employee.

In some instances, shift planning feature 461 allows users to select time preferences and identifies the employees whose shifts match both the filters and the employee's time preferences. The shift planning feature 461 can inform a user through the user interface 450 or via an alternative communication channel (e.g., sending an email or other message notification) that someone may be available to take over their shift. If users opt in to sharing their shift, an approval process for such change in shifts can be triggered. A user's profile can be configured to allow, reject, or ask for approval upon request, when a shift change request is received. For example, a user's profile of a first user can be configured that if another user asks to take a shared shift, the first user may receive a request to approve moving the shift to the other user. Such configurations can be set at the shift planning feature 461, where requests for shift changes are evaluated and possible options for new shifts are determined. Further, shift changes can be configured for additional approvals. For example, a request for approval can be sent to a manager in charge and, upon approval, the shift can subsequently handed over to the employee. In some more instances, if these is an approval by an authorized user, approvals by the user whose shift is taken may not be requested. For example, an authorized user may be a manager, supervisor, among other type of users or roles of the enterprise.

In some instances, personal finance management configurations can be configured at the payment platform service 445 to help users manage their personal finances. For example, a user, being an employee and being provided with access to the payment platform service, can set limits on available payouts. In some instances, limits to available payouts can be provided with default limits as an upper limit for an amount to be provided based on a request for an advance payment. The user can configure dedicated parts of their income to various purposes (e.g., rent, groceries, fuel, savings, etc.). When a user request advances, payment platform service 445 may allow the user to track how he uses the received advances. In response to tracking advances received by the user, the payment platform service 445 may provide alerts to the user about risks of overspending. For example, when a user opens the user interface 450 of the payment platform service 445, the user may interact with the user interface 450 to configure portions of their earnings for particular purposes. The user may be provided with options to track his spending associated with earned compensation (e.g., salaries, advance payments, bonuses, other) from his employer.

In some instances, when a user is at the risk of overspending by decreasing his net amount in the payment platform service, payment platform service 445 can initiate shift planning options as provided by the shift planning feature 461.

In some instances, a user who is an employee of an enterprise may use the provided budgeting capabilities the payment platform service 445 by providing input on spending patterns that can be used when defining planning for against advances. In some more instances, the payment platform service 445 may be integrated with an interface to communicate with a bank system and consume data from an employee's bank account to evaluate and categorize spending behavior of the user (employee). In some instances, past advance payment patterns and information provided by the employee regarding their financial preferences for spending their income may be matched to provide recommendations for initiating shift planning and requesting of advance payments. For example, data for financial preferences for spending and utilization of advance payment and scheduling of additional shift may be acquired through executing of micro-surveys to capture data from the user about experience related to spending and need of advance spending.

The net amount provided in the payment platforms service 445 may be net amount available for spending by the user. The payment platform service 445 may be integrated with other payment systems to receive notifications for transactions performed by the user that reduce the net amount as identified in the payment platform service. The user can initiate obtaining data from employers' time and attendance systems to suggest additional shifts for the user that can fund advances to compensate for a decrease of the net amount available to the user.

In some instances, the payment platform service 445 can provide financial overview data to employees to help them manage their finances. In some instances, the payment platform service 445 may provide services to dedicate payouts to given purposes, for example, paying for a medical bill, a car repair, a leasing payment, or a phone bill. Users of the payment platform service may provide information about their fixed payments and/or their latest or most recent number of transactions. Based on acquiring such data from the users, the payment platform service 445 can perform categorization of the user's information to a predefined payment purpose category. A library of a plurality of payment purpose categories can be set up at the payment platform service 445. For example, a medical bill can be categorized in the context of managing healthcare costs or paying your bills more broadly. Alternatively, body of the text included in the information provided by the user can be indexed based on the library. Further, a comment provided by the user can be used as a search term into the index to identify a category for a received input. Over time, user's explicit and implicit feedback can be captured to improve categorization of user's comments associated with performed payouts. User feedback can include identification whether what he or she is presented as content corresponds to his needs and preferences.

In some instances, received user feedback can be processed in multiple stages using deep-learning-based approaches. For example, the user feedback may be processed based on train classifiers for text input based on publicly available data. As another example, users may be asked to provide textual input as an initial action along with categorial input (for example, based on a predefined selection based on classifiers) to label additional training data. As yet another example, the user feedback may be processed according to an improved classifier approach based on information provided by the employee. Further, in cases where budgeting options and/or account information are available, input defining categories for the spending and allocated portions of the budget may be provided in advance to be matched with payment information. For example, an employee may receive an advance payment for healthcare, when expected expenses in his account match a category healthcare for such an advance payment. Based on processing user feedback, the payment service may further learn how advances will be used and acknowledge the impact this is going to have on users' budgets.

In some instances, based on labeled data associated with categories for spending and allocated budget for different purposes, a predicted risk level for spending more than what is expected to be earned can be determined and provided as a warning on the user interface. In some cases, in addition and/or as an alternative to the warning, a display of one or more options for undertaking additional shifts can be provided on the user interface. The prediction can be performed, for example, by predicting an employee's income in the current pay cycle based on past income and current scheduled working hours, e.g., using deep neural networks. As another example, the prediction can be performed by comparing a predicted income with their budgeting information. If an employee is predicted to earn $400 and they need $200 for rent and $150 for groceries, and if they decide to request to receive an advance payment of $60 for a medical bill, then it can be determined that the employee will be $10 short, and a notice (e.g., warning) can be provided. In the present example, options with additional shifts can be provided based on determined possible shortfalls in the pay-cycle balance.

In some instances, based on further categorization of payouts (e.g., as medical expense, groceries, rent, etc.), the payment platform service 445 can also help employees manage their budgets. An advanced feature of payment platform service 445 may provide users with the option to determine how much of their salaries they are spending on various categories. For example, the payment platform service 445 can provide an overview of spending including payments for rent, groceries, fuel, transportation, leisure, and sporadical expenses, among others.

In some instances, using this budgeting feature in conjunction with a categorization of expenses, the payment platform service 445 can alert employees when they are at risk of overspending relative to one of the recorded categories. For example, if an employee planned for 10% of their salary for leisure and they took 12% of their accrued earnings, the employee can be notified and based on that he may opt to continue with the payout or cancel. In such cases, the user may be provided with an option to request to work on additional shifts to increase an available balance that can be calculated by the payment platform service 445 and to get back on track with their budget.

In some instances, the payment platform service 445 determines an acceptable amount by evaluating the acquired data one or more systems at the customer system environment 410, as discussed in relation to FIG. 2 and/or FIG. 3.

In some instances, a feedback service 480 may be implemented and communicatively coupled to the payment platform service 445. The feedback service 480 may be provided as part of the payment platform service 445 or as a standalone component independent of the payment platform service 445 and the customer system environment 410.

In some instances, the feedback service 480 can continuously or periodically monitor user experiences, interactions of user with the payment platform service 445 to request advance payments, and performed configurations or shift planning. The feedback service 480 can monitor the interactions and determine key performance indicators that affect the financial behavior and well-being of users. To do so, the feedback service 480 may implement surveys and micro-surveys with employees, reads key performance indicators from employers' software systems, and uses statistical computing calculate effects. Micro-surveys can include a set of basic questions related to an employee's financial well-being that are presented to the user spread out across time to get an ongoing pulse of their well-being. Such questions may include, but are not limited to, ranking of appreciation of the provided services of the payment platform service 445 by the users. Example questions may include: “How much did you feel in control of your finances during the last week on a scale from 1 to 10?,” “How much have financial issues impacted your wellbeing during the last week on a scale from 1 to 10?,” and “How often did you think about financial issues during the last week?,” among others.

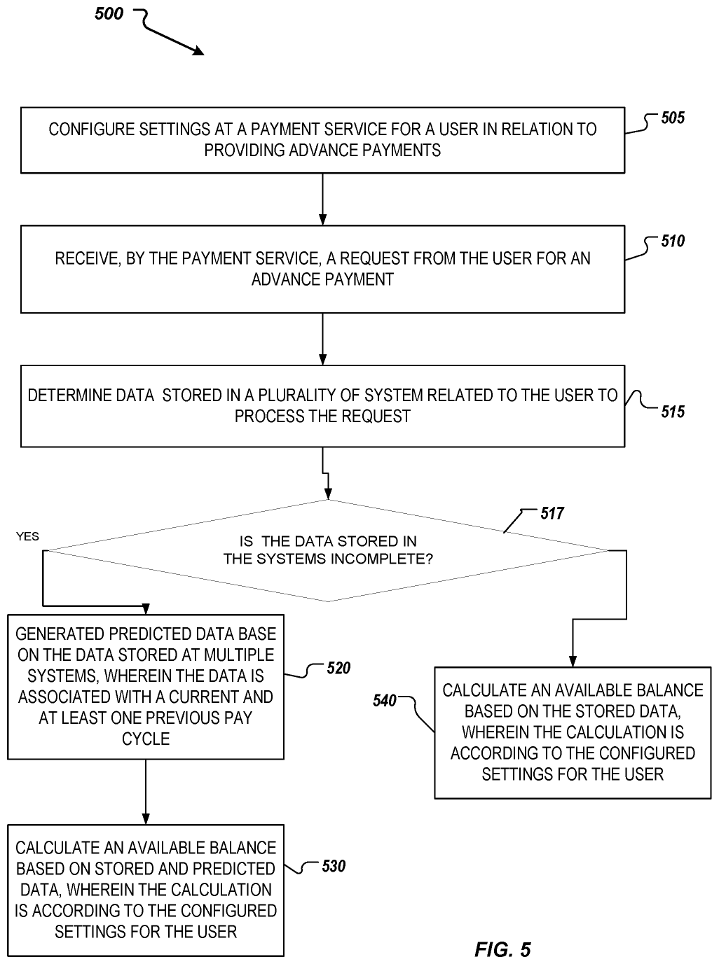

FIG. 5 is a flowchart for an example method 500 for calculating an available balance based on stored and predicted data in accordance with implementations of the present disclosure.

At 505, settings for a user are configured at a payment service. The payment service may be similar to or different than the payment service 205 of FIG. 3, the platform service of FIG. 3, and the payment platform service 445 of FIG. 4. The configuration settings may be associated with a user who is an employee of an enterprise. The settings may be related to limitations for providing advance payments for the user, and/or may identify a portion of the earned benefits or compensation of the employee that can be used and allocated to advance payments. For example, the settings may include a limit of a number of days that can be paid as advance payment. As another example, a setting can define that an employee's bonus can be used for calculations of advance payments, and thus can be used in calculations as soon as the bonus has been awarded to the employee, but prior to its disbursement.

At 510, a request is received from the user at the payment service for an advance payment.

At 515, data stored in a plurality of systems and that is related to the user is determined. The plurality of systems may be associated with the enterprise that is an employer of the user. The determined data can be related to the request and may be associated with performed work, tasks, or eligible compensations and benefits allocated to the user. The plurality of systems may be corporate systems, such as those discussed in relation to FIG. 2 at the enterprise platform infrastructure 210.

At 517, it is determined whether the data stored in the plurality of systems is incomplete.

At 520, in response to determining that the data stored in the plurality of systems is incomplete (at 517), predicted data is generated. The generation of predicted data may correspond to the prediction of hours as described at the hours prediction component 202 of the payment service 205 of FIG. 2. The predicted data may be based on data that is stored in one or more of the plurality of systems and that may be associated with the current pay cycle as well as one or more previous pay cycles (i.e., historic data). Any other suitable method or operation for estimating the data can be used.

At 530, an available balance is calculated. The calculation of the available balance can be based on data stored in the plurality of systems, predicted data as generated at 530, and configured settings for the requesting user (as configured at 505).

At 540, in response to determining that the data stored in the plurality of systems is complete (at 517), an available balance is calculated based on data stored in the plurality of systems and configured settings for the requesting user (as configured at 505).

For example, once the balance is calculated (at either 530 or 540), it can be presented to the user, and the presented available balance amount can be selected as accepted (or a part of it can be accepted) for receiving as an advance payment. If accepted, then it can be processed and paid out in response to the request and/or an approval of the certain amount desired.

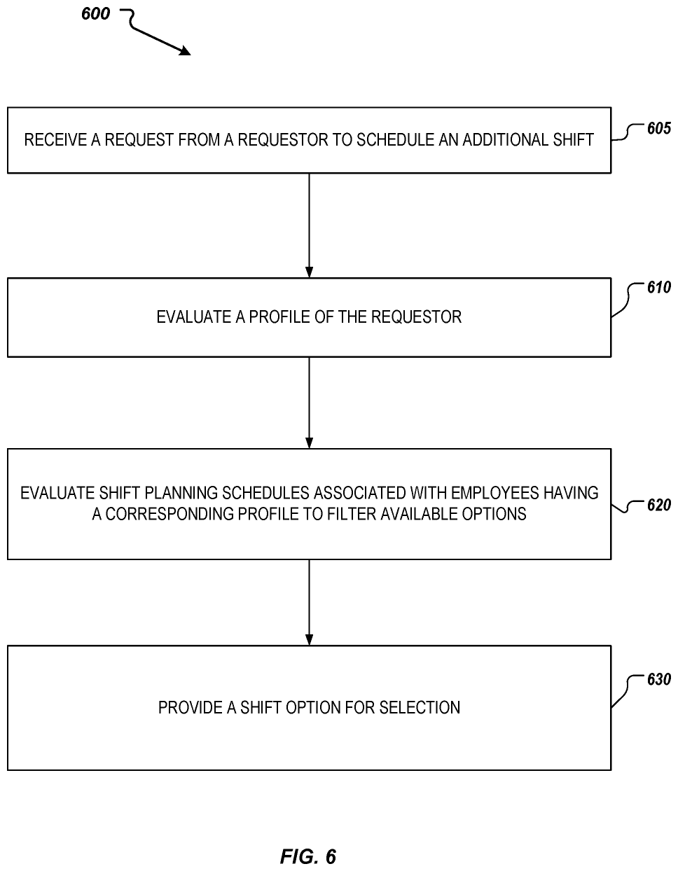

FIG. 6 is a flowchart for an example method 600 for requesting shift rescheduling in accordance with implementations of the present disclosure. The example method 600 can be executed at a payment service and may be related to processing a shift rescheduling request. The payment service may include shift planning logic such as the shift planning features 461 of the payment platform service 445 of FIG. 4.

At 605, a request is received from a requestor to schedule an additional shift.

At 610, a profile of the requestor is evaluated.

At 620, shift planning schedules are evaluated to filter available options for scheduling an additional shift for the requestor. The shift planning schedules can be evaluated to determined scheduled shifts for employees having a corresponding profile to the requestor's profile. Further, the scheduled shifts corresponding to employees having a corresponding profile can be filtered to determine a shift option that correspond to the request. In some instances, a request to shift schedules may require approval from the employee whose schedule may be shifted if identified as an option. For example, as part of the evaluation of the planning schedules to determine available options, the employee who is associated with the available option may be requested to approve the request for the additional shift of the requestor. Additionally or alternatively, an additional or replacement approval by an authorized approval (e.g., a manager of the requesting employee), may also be requested when an identified shift is evaluated and determined as an available option for scheduling as an additional shift for the requestor.

At 630, a shift option is provided to the requestor for selection. Once the user selects the shift option, such a selection may trigger a change in the shift that are planned and scheduled. Thus, the selected shift can be reassigned from the previously identified scheduled employee to the requestor.

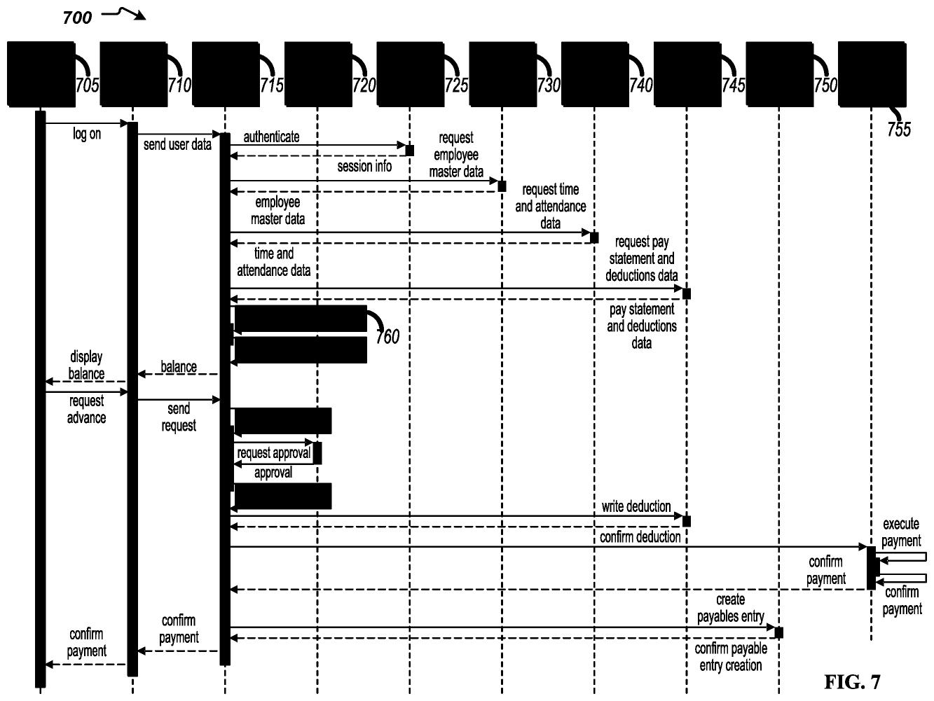

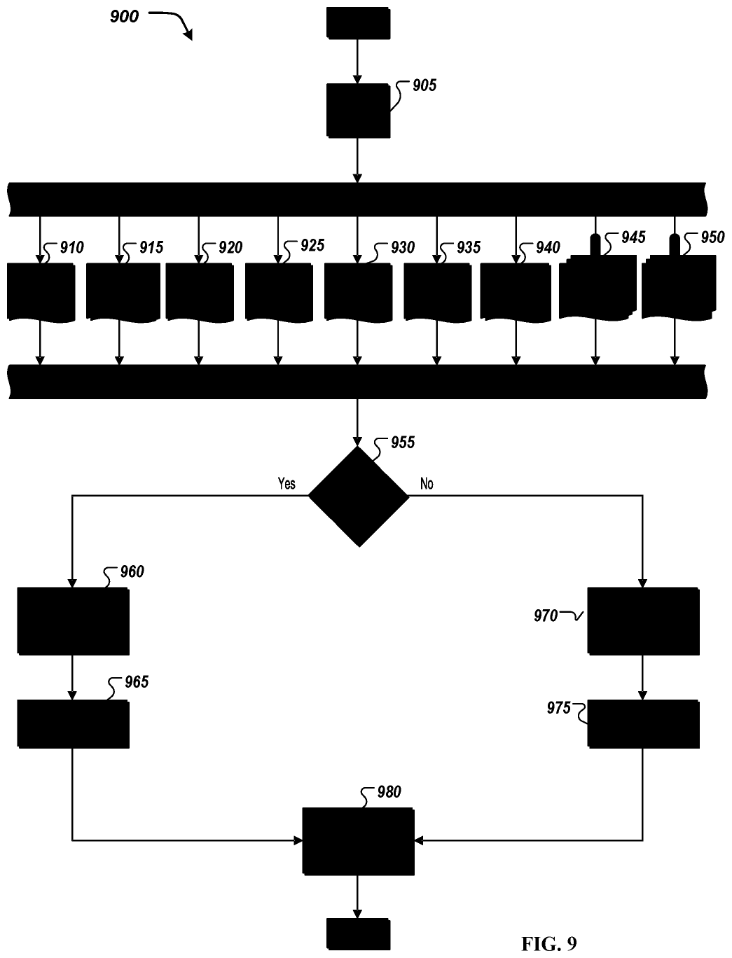

FIG. 7 is a flowchart for an example method 700 for executing service request at a payment service integrated with enterprise systems in accordance with implementations of the present disclosure. The example method 700 can be executed in relation to a user 705 requesting an advance payment from a payment application 710. The user 705 can log on to the payment application 710. The user 705 is an employee of an employer 720 associated with corporate systems. The payment application 710 is communicatively coupled to a payment server 715 that includes logic to acquire data from different systems of an employer of the user. The payment application 710 and the payment server 715 may incorporate logic for performing calculations of an available balance that can be allocated to the requestor. For example, the payment application 710 can read data from multiple systems, such as the Identity Provider service (IdP) 725, the core HR system 730, the time and attendance system 740, the payroll system 745, and the finance system 750. Reading such information may be similar to the communication described between the payment service 205 and the systems at the enterprise platform infrastructure 210 of FIG. 2, and/or using the data read operation performed at 905 of FIG. 9, among other suitable methods.

The payment server 715 acquires data related to performed work of the requestor, eligible benefits, approved hours, among others, and calculated an available balance (at 760). The calculation of the available balance can be similar to or different from the calculation at 340 of FIG. 3 and/or the calculation at 965 or 975 of FIG. 9 (as discussed below). The available balance as calculated is persisted on the payment server 715. Thus, the payment server 715 can dynamically process requests for advances when a request from a user, such as user 705, is received. In some instances, the request may be similar to the request received at 310 of FIG. 3.

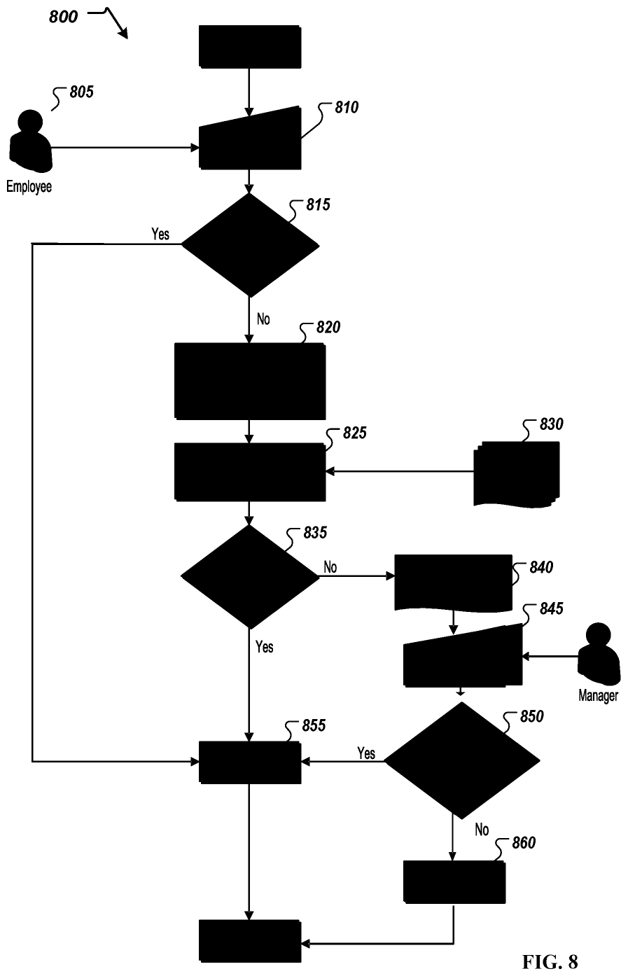

FIG. 8 is a flowchart for an example method 800 for automatic approval of work hours of an employee in accordance with implementations of the present disclosure. The example method 800 may be implemented as part of the logic implemented at a platform service, such as the payment service 205 of FIG. 2, the platform service discussed at FIG. 3, the payment platform service 445 of FIG. 4, among others.

In some instances, payments to employees can typically only be made based on approved working hours. Even in cases where employees track their time using time capturing systems, employees' managers may still need to approve worked hours before employees' eligibility is confirmed. In some cases, upon approval of worked hours, an employee can be paid based on these working hours. In some cases, these working hours are not approved in real time, but often at the end of the pay cycle, for example, just before a corresponding payroll run for that pay cycle is to be executed. To address such a constraint, a payment service can be configured to either initiate an approval process, for example, to ask for managers' approvals during an employee's request in real time, or to predict whether the time entry would be or would not be approved based on past approval data. In some instances, a combination of both processes can be provided. If a confidence level of a prediction for an approval of entered working hours exceeds a predefined configured confidence level, then the working hours can be considered to be approved; otherwise, an employee's manager may manually need to approve the request to allow for the advance payment request to be processed.

At 810, an employee 805 may request an advance payment for a period of time (e.g., work time in days and/or hours). For example, the request at 810 may be similar to the request received at 310 and at a platform service for payment requests evaluations as discussed in FIG. 3.

At 815, an evaluation is performed to determine whether the request for an advance is covered by validated time records. For example, the validated time records may be time records entered by the employee at a time record system of the enterprise, where these time records are approved, for example, by a manager of the employee. If it is determined that the requested advance, for example, a payment for 5 days, is covered by validated time of 5 days, then the request for advance payment is allowed and executed at 855.

If it is determined that the advance is not covered by validated time records (at 815), a determination of an amount of hours that are not covered by approved hours is performed at 820. For example, if the employee's request at 810 is for advance payment for five (5) days corresponding to forty (40) working hours, and if the hours that are approved for his time records are thirty-five (35), then it can be determined that five (5) hours of his records are not approved, and thus the approved set of hours does not cover the advance as requested.

At 825, a comparison is made between the determined hours (at 820) and historically validated (or approved) hours for the employee. The comparison is performed based on historical time records 830 that store validated/approved hours for employees of the enterprise.

In some instances, approval of working hours that are tracked in time recording systems (or that are predicted as working hours, as discussed in the present disclosure) may be performed according to different algorithms.

In some instances, the approval of worked hours can be based on a confidence threshold approval prediction. According to one example prediction method, approvals can be predicted using a configurable threshold parameter p between 0 and 1, where p reflects a confidence value that an approval for worked hours is to be given if at least a fraction p of the employee's past recorded hours (historical time records 830) have been approved in the last k pay cycles, where k is a parameter that can be configured. Based on a confidence level of 95%, an overpayment would only occur in at most 5% of the worked hours, resulting in a significantly less than 5% overpayment expectation. For example, if an employee recorded 1000 hours of work during the last 6 months and 980 of these have been approved, that employee's approval rate was 98% or 0.98. Based on a 95% confidence level, the prediction system would automatically approve the payment. If the approval rate was 98%, it can be interpreted that an approval (if given) would only be expected to be wrong in less than 2% of the cases, resulting in a significantly less than 2% overpayment. If the employee's approval rate was only 90%, the confidence threshold may not be met, and the implemented approval logic may be configured to initiate an approval process in real time at 840. A request for approval can be initiated (at 845) for an approval on the hours at question. For example, the request can be sent to a manager who is assigned to approve hours for the employee.

In other instances, if the historical time records 530 include little to no approval history when the request is received from a newly hired employee, the approval performed at 835 based on the historical time records 830 can be performed based on historical data associated with employees having a similar profile as the employee 805.

Further, in some instances, an approval prediction algorithm may be modified to exclude certain working hours or days that fall outside of a normal definition, for example, through a configuration implemented in one of the systems of the enterprise. In some instances, exclusions can be configured in multiple ways. For example, overtime and/or weekend work may not be approved automatically if such work patterns do not occur frequently. In some cases when analyzing patterns of work to determine exceptions, statistical outliers, e.g., a 12-hours/day in an otherwise 3-5 hour/day schedule or average according to the working history, may not considered.

In some instance, neural networks can be used to provide prediction services in relation to approvals. Based on machine learning logic approvals can be predicted in a supervised scenario, using past time recordings and approvals as inputs along with non-personal information, such as, work schedules, seasonal business fluctuations, type of work or project performed, etc.

In some instances, approval data can be classified using supervised learning techniques (e.g., logistic regression) to predict whether a given set of working hours will be approved or not. The confidence level of the classifier technique can be used to initiate a manual approval of entered hours whenever the confidence levels associated with the prediction are below a certain threshold value. For example, even if the classifier has a confidence level of 0.7 that the hours will be automatically approved, customers may choose to manually approve hours in this scenario. In some cases, approving of hours may be dependent on certain employee master data. If an employee is a new employee or if the employee has been marked as ‘likely to leave’ in the HR system, or other criteria that identifies the user as relevant for manual approval, the entered data for worked hours will be configured to be requested for manual approval. For example, if the confidence level is 0.3, an approval should not be automatically executed without manual revisions. Further configuration for distinction between manual and automatic approval of recorded hours may be provided.

At 850, it is determined whether an approval is provided as requested at 845. If the approval is provided, the request for an advance is executed at 855. If the approval is not provided, then, and 860, the request is aborted and a rejection is sent to the employee 805.

FIG. 9 is a flowchart for an example method 900 for calculating an available balance for an employee of an enterprise in accordance with implementations of the present disclosure. In some instances, the example method 900 can be executed by a platform service, such as the services described in FIGS. 1-8 above.

The example method 900 can be executed in response to a received request from a user for an advance payment associated with a requested period of time. The user who requests the advance payment may be an employee of an enterprise associated with multiple systems, including systems storing data and records for performed work, awarded benefits, compensations, garnishments, specific employee configurations, among other. Based on the received request, an available balance amount can be determined to be allocated to the requestor as the advance payment. For the calculation of the available balance amount, data from at least one of the systems associated with the enterprise can be acquired and processed, for example, according to simulation logic or to prediction logic.

In some instances, data related to garnishments 940 may be read. In some instances, employee's net pay can be affected by garnishments thus they may be taken in account for the calculation of the available balance. In case of a payroll simulation execution, all the previous garnishments and the all the new garnishment orders present in the system may be taken into consideration for net pay calculation.

In some instances, the platform service can provide a mechanism for configuring the handling of garnishment while calculating the available balance. For example, garnishments can be categorized as pre-existing and new. Pre-existing garnishments are those garnishments that are already taken into consideration in previous pay cycles, while new garnishments are those that have been entered in the systems of the employer and had occurred in the current pay cycle. Employee's previous net pay can be determined by deducting pre-existing garnishments, while new garnishments have not yet been considered in any pay cycle.

In some instances, garnishments can be classified into types, such as support (child, spousal, and medical), federal debts (student loans and administrative wage garnishments), federal and state tax levies, creditors, and voluntarily, among others. Some or all of the different types of garnishments may be configured to reduce the available balance that can be paid as an advances. For example, some types of garnishments that are new garnishment may be excluded from the calculations of the available balance, thus allowing an employee to receive an advance payment even where new garnishments exist. In some other examples, other types of garnishments may be fixed in the logic of the available balance calculation to reduce the amount of the available balance and/or not to allow an employee to receive advanced payments under certain constraints. In some cases, the list of different garnishments and corresponding to being new or pre-existing can be configured with a corresponding allowed or not-allowed property. In such instances, an allowed property can identify that a correspondingly associated garnishment (of a given type and classified as new or pre-existing) is included in the calculations thus reduce the available amount, and a not-allowed property can identify that a corresponding garnishment is excluded and thus do not reduce the available amount.

The data as read at 905 can also include data for bonuses, which, for example, may be includes as part of the read compensation data 915. The platform service may allow employees not only to tap into their already earned but yet unpaid compensation, but may also enable employers to directly pay out portions of bonuses that are awarded due to an outstanding work performance and/or profit sharing. This allows employers to more directly reward work performance through monetary bonuses which are not timely detached from the actual work performance of the respective employees. Leveraging the available balance prediction and in a later stage of a payroll simulation will allow the platform service to determine and at least partially calculate an allocated bonus, where that bonus can then be paid out as an advance payment shortly after it has been awarded.

In some instances, the read data may include data for overtime, for example, as part of the time records 925 data. When a non-exempt employee works overtime, weekends, and/or public holidays due to the company requirements, an employee may be eligible for overtime payment that can be regulated by the employer and national employment law. Calculating an overtime amount is performed as part of determining earned income by an employee. In a simulation of payments, for example, the payroll can be simulated to reduce the complexity of the calculations and to calculate payouts accordingly. In the absence of an execution of a payroll simulation, the platform service can calculate overtime as regular working hours and calculates the amount using appropriate formulas, such as: a=h*r, where h is equal to the overtime hours, r is equal to the hourly wage for an employee and a is the calculated overtime amount. When the available balance is calculated, the calculated overtime amount is added to the regular earned wage to determine the total earned wages for calculating an estimated available balance. In some instances, the use of data related to overtime payment in computing an available balance can be configured by the employee or the employer. For example, a user may configure the system to include or to exclude the overtime hours for current and future calculating of an available balance amount.

In some instances, the platform service can scan through the systems, such as the payroll system, and determine if there is any one-time or recurring payment which would be made available to the employee at the end of pay cycle apart from the regular work pay. That determination can then be included in the data that is read at 905.

At 905, data from corporate systems of the enterprise is read. Such read data can be used for execution of calculations for the available balance amount that can be allocated to the requestor. In some instances, the read data includes master data 910, compensation data 915, work schedule 920, time records 925, absences 930, deductions 935, garnishments 940, historical time records 945, historical pay statements 950.

In some instances, the read data for the employee defines performed work tasks, compensation, and eligible benefits for allocating money to the requestor. The read data is evaluated to determine an estimation of compensation for performed work and allocated benefits for the requested period. The determined estimation based on the read data is evaluated according to processing rules defined in relation to different properties of the data to provide a real-time estimation of an amount (e.g., an available balance), which can be advanced to the requestor prior to a next payroll compensation execution.

The read data can be evaluated to determine whether it is complete and available for use in performing an evaluation of the received request. For example, there may be missing data, such as not entered time records, or there may be data that is not approved. Thus, based on the data evaluation, further computations can be performed to predict missing data or to predict approval of time records, where those additional computations and prediction provide additional estimated data that is sufficient for using when determining an available balance amount for an advance payment, where that amount complies with a predefined criteria associated with low risk of overpayment.

At 955, it is evaluated whether the systems associated with the enterprise support execution of a simulation.

If it is determined that simulation is supported, then at 960 data is loaded in a simulation framework. At 965, a payroll simulation is executed.

In some instances when simulation is supported, shadow data structures can be created to include predicted data in addition to the data stored in the payroll systems. In some instances, when simulation is performed, the simulation can be executed through a software library that be called and provided with the shadow data structures as input, or, alternatively, the simulation can be executed as a payroll simulation service that can be parameterized to use the shadow data structures as input. In some instances, a payroll simulation service may be implemented as a standalone component that can be exposed via an API or through a remote function call to provide results associated with estimations of available balance for providing advance payments. In some instances, the payroll simulation service may be a cloud or an on-premise service.

In some instance, an available balance can be calculated through simulating a complete payroll run based on the available data (as read at 905). Available data that can be used for the simulation can be referred to as both real data that is captured from the employer's systems of record as well as predicted data that is determined by prediction logic associated with the platform service executing the request for an advance payment. In some instances, if real data is not persistent in the systems, then predicted data can be generated and used for the available balance calculations. Various algorithms can be used to determine predicted data based on incomplete real data from the current pay cycle (current data) as well as real data from past pay cycles (historical data).

In some instances, when payroll simulation is performed, shadow data can be created and stored in a payroll system to mimic the real data for performing payroll simulation and to run a payroll process at the payroll systems on the shadow data and the real data. The outputs of the payroll simulation can be persisted directly at a payment platform service executing the method 900. In some instances, real data is not available for the period requested for an advance payment. In those instances, the shadow data may be partially filled with predicted data. In some instances, and to speed up the computation, functionality not needed during the simulation can be switched off, including, for instance, persistence of specific tax outcomes.

If simulation is determined as not supported at 955, read data is loaded (at 970) at a machine learning prediction framework. At 975, a machine learning payroll prediction is executed.

In some instances, a prediction model may be implemented at the platform service to determine a real time estimation of an eligible amount to be transferred to the requestor based on his attendance, performance, and expected compensations as indicated in the multiple system provisioned and running to store data for an enterprise (employer or work provider) and their employees (requestor). The platform service may use the prediction model and a native integration with the systems of the enterprise to serve requests in real time. The implemented prediction model may provide estimation of compensation for performed work that correspond to a real time prediction. The real time prediction of the compensation for performed work and allocated benefits for the period at question may be evaluated according to encoded processing rules at a machine-leaning (ML) payroll prediction model that can be part of the platform service. These processing rules may support an intelligent and automated process execution to serve requests at real time. The implemented platform service and logic provides accurate estimations of amounts for advance payments based on the data that is stored is used for the prediction as reflected in the systems at the moment of the estimation. The estimation of the amount for advance payment is determined as an eligible amount to be allocated to an employee, where the estimation is associated with a relatively low risk of overpayment. The estimated amount is determined to provide guarantees for allowable funds for the advance, as the estimate is based on the data that includes current data available at systems and predicted data based on the prediction data generation logic.

In some instances, the determination of an available balance at 980 is performed to determine a monetized amount corresponding to performed work activities and assigned benefits for the requestor. The monetization is performed according to processing rules encoded in the platform service that may be configured by the enterprise as the employer of the requestor. Further, the monetization may be performed based on consideration of the funding provider being the entity that bears the risk of paying the advance payment equal to the determined available balance. The funding provider may configure constrains in an attempt to control the risk of loaning money before the end of the pay cycle. The processing rules are defined to measure the properties of the data that is read from the related systems. A predictive model that can be selected and used to determine the acceptable amount at real time applies data evaluation based on measures of the properties in relation to predefined threshold values by the enterprise and the funding provider.

In some instances, and when payroll simulation is not possible (for example, due to corporate system constraints for accessing and modifying data), an available balance can be determined based on current and/or historical data, and also may be based on currently available data and/or predicted data, or a combination thereof. There may be various algorithms for calculating predictions of available balances based on a received request. A particular one can be selected and configured to be used for example in relation to particular requests coming from a user, a group of users, employees of a given enterprise, among other.

In some instances, the various algorithms that can be used to predict an available amount can be based on a parameter search paradigm. To limit a financial downside for employers resulting from potential overpayment and the number of overpaid employees, a platform service implementing logic to process requests for advance payments and calculating available balance can provide a parameter search framework. The parameter search framework may be based on Monte-Carlo Simulations that may facilitate to provide additional statistical guarantees for estimations and/or prediction of available balance amount that correspond to expected confidence levels predefined by employers.

In some instances, a calculation of an available balance can be associated with risks of predicting amounts that are higher than what an employee would be compensated if the compensation was executed at the normal pay cycle, as the calculations are associated with predictions executed on top of predicted data. Therefore, when performing prediction for an available balance that can be allocated to a requestor, parameters that can be used can be selected to reduce such risks of overpayment. Thus, an optimization for determining the estimated available balance can be performed to reduce a number of overpaid employees and a total amount of overpayment for the enterprise. To execute such an optimization, random parameters can be selected in a predefined range for a prediction of worked hours. In cases where an algorithm provides statistical guarantees, a corresponding formulae can be used to determine such parameters according to employer (e.g., enterprise) preferences. Monte-Carlo simulations can be executed and can use the chosen parameters to compute expected values and distributions for the outputs to be optimized.

In some instances, the Monte-Carlo simulation can be performed during configuration of a setup and testing of computations to determine estimated available balance. Based on Monte-Carlo simulations, the estimation model may be optimized by adjusting one or more of the model parameters to minimize overpayment when generating estimations. In some cases, based on observed usage patterns across customers, a data generator can be provided to generate sample advance request having corresponding data patterns. Such sample advance requests may be defined based on frequently occurring or expected to occur requests that have particular structure and share characteristics, for example, originating from companies of a similar industry, geography, workforce, pay ranges, revenue, among other company characteristics. Such samples can be generated based on a multi-variate Gaussian sampler parameterized by multi-variate Gaussian distributions learned from past data patterns observer at historical data. In some instances, a large number of samples can be generated and fed into the logic for determining the available balance as sample input. In some instances, parameters of the model framework for calculating available balance that can be paid as an advance payment may be initialized with default values. For each sample, an amount of overpayment can be calculated and compare to an employers' maximum overpayment threshold value, for example, no more than an average of $25 per employee per year. If the overpayment is higher than the employer-set threshold, some of the parameters may be adjusted accordingly to employers preferences.

In some instances, multiple adjustment scenarios can be selected based on the observed overpayment patterns. For example, if primarily new employees are overpaid, then the maximum amount available to new employees can be more strictly limited, or if some employees are overpaid significant amounts, then the corresponding employees can be treated as a separate group of employees with their own payment thresholds (e.g., holiday workers).

In some instances, overpayment can be calculated for each employee individually as a difference between a salary determined with a simulated payroll algorithm to correspond to an expected payment at the end of the simulated pay cycle, and the total amount of payments made to the employee during the pay cycle, including advances. In some instances, an overpayment may occur if there is a garnishment. For example, an employee can earn $100 in a given pay cycle. After one week, the employee may receive an advance payment of $50, and a few days later, there can be a new garnishment of $60 applied to employee payments for the pay cycle. Since the employer has to cover the garnishment of $60 and the employee already received an advance payment of $50, the employee would have been paid $110 (including the garnishment) instead of $100, i.e., there is a $10 overpayment. In addition, the overpayments can be later summed up for all employees to calculate the total overpayment. In some instances, an employer can set a threshold value for one or more individual employees, or, alternatively, for the total overpayment for all employees, during the configuration.

If the outcomes that are optimized exceed thresholds defined by the employer, for example, because the expected number of overpaid employees is too high or because the expected total overpayment amount is too high, a random parameter is chosen and is increased or decreased accordingly, until the desired thresholds are reached. Note that this is always possible at the expense of lowering the available balance.

### Gross Fraction Available Balance Prediction

In some instances, a gross fraction available balance prediction method can be used to determine the available balance. Using the parameter search framework, a number that can be referred to as a gross factor can be determined to calculate the available balance as a fraction p of an employee's accrued gross earnings to date. For example, if gₜ represents an employee's accrued gross salary at time t, then the available balance b is computed as formula (1) b=p*gₜ, where p is determined such that either the expected overpayment or the number of overpaid employees or both is below a threshold defined by the customer. Consequently, p can either be determined statistically as the expected value of these numbers based on the distribution of employees' past paychecks or based on a Monte-Carlo simulation as described in in relation to the parameter search framework. Additional factors that can be taken into account include predicted or scheduled working hours.

### Net Prediction of Available Balance

A net prediction algorithm can be used to calculate the available balance based on past earnings and current working hours as follows. Let g=(g₁, . . . , gₖ₋₁) be an employee's gross earnings. Let n=(n₁, . . . nₖ₋₁) be an employee's net earnings in the last k pay cycles preceding the current pay cycle k. Let hₖ be the employee's worked hours in pay cycle k, let r be the employee's gross hourly rate as well as e the employer rate. Then the employee's available balance b is calculated as in formula (2) b=min_{{i=1 . . . k-1}}nᵢ/gᵢ*r*hₖ*e. The ratio nᵢ/gᵢ can be referred as a net ratio of the employee in pay cycle i. In some instances, formula (2) can be modified to exclude pay cycles that are out of the ordinary, for example, if the employee had an exceptional one-time deduction in any of the past k−1 pay cycles. Similarly, the net prediction of available balance algorithm can be modified to only include pay cycles that resembled the current pay cycle in terms of work schedule, worked hours, seasonality, existing deductions or garnishment, etc. Such modifications can be configured by the employer to exclude certain specific deductions or to exclude defined outlier pay cycles. For example, a t-th pay cycles with the lowest ratio of nᵢ/gᵢ, where t is a configurable parameter can be excluded, or all pay cycles whose ratio nᵢ/gᵢ lies outside of a defined interval around the mean of these ratios can be excluded.

Net Prediction of Available Balance for Employees with Short Pay History

In some instances, for some employees, there is only little or no information available on previous pay cycles (e.g., new hires). In such cases, a prediction algorithm can be configured to calculate the available balance by similar to the described net prediction algorithm above, except that it can substitute the minimum ratio nᵢ/gᵢ over the previous pay cycles by a minimum over all employees' past pay cycles chosen from a defined group of similar employees. For example, E can be defined as a group of employees similar to a given employee with small pay history. Then the available balance can be computed as defined in formula (3):

b=min_{{f from E}}min_{{selected pay cycles i}}nᵢ^{f}/gᵢ^{f}*r*hₖ*e, (3)

where nᵢ^{f} denotes employee f's pay in pay cycle i.

For example, a new hire can be associated with a request for an advance payment and E can be a set of employees who have been hired in the last k pay cycles. Then the employee's available balance can be calculated as the product of the employee's hours with his or her gross rate, the employer rate, and the minimum net rate of all new hires from the last k pay cycles during their first pay cycle. In some instances, formula (3) can be modified to exclude certain employees, for example, employees who have had exceptionally high garnishments. Such exclusions can provide certain statistical guarantees to the employer about probability of over-payments. For example, under an assumption that the population E is representative of the current population of new hires, overpayment can expected to happen in 5% of the cases if we exclude the 5% of the population with the lowest net ratios. In such cases, an employer can provide high available balances as advance payments to employees with small pay history while at the same time managing the risk of overpayment as a whole.

### Advanced Net Prediction of Available Balance

In some instances, an advanced net prediction of available balance algorithm can be used to make prediction in a reliable and accurate manner by including data from a current pay cycle. In some instances, new deductions and garnishments for the current pay cycle that have not been considered in past pay cycles can be used to further reduce the available balance can be applied for the calculations of the available balance. Deductions and garnishments that ended in the previous pay cycle can be used to modify the available balance. Further, other events recorded or scheduled for the current pay cycle, can be configured to be incorporated in the calculation of the available balance, such as scheduled time off, recorded sickness, termination, etc.

In some instances, new deductions can be defined as deductions that have been introduced in the current pay cycle (e.g., month). A new deduction may be a deduction that was not present in the data associated with previous pay cycles. For example, if a new benefit was introduced or used by the employee, such a deduction may not be available and/or applicable for the employees in past payment cycles. Further, a net prediction algorithm may be used to work with data from past pay cycles. In some cases, where deductions are frequently added or removed, an advanced net prediction can be used.

In some instances, the advanced net prediction algorithm can compute a net ratio as nᵢ′ and calculate it as presented in formula (3) above where as nᵢ′ can be calculated according to the formula for n′. The calculated value of nᵢ′ can be interpreted as the modified net income calculated by adding all deductions that can be allocated to a current pay cycle (e.g., month) and subtracting the deductions that can come on top. In some instances, the calculated value may correspond to a situation as if the current pay cycle has occurred and all deductions and allocated benefits are assigned.

### Neural Net Prediction of Available Balance

In some instances, the available balance can be calculated based on prediction logic and using neural networks that take both data from past and present pay cycles as inputs. These neural networks can be trained in a supervised way using the data available from employees of the enterprises that can be stored in associated corporate systems. In some instances, to reduce a risk of bias for the generated results based on race, gender, origin or other, the training data may only include basic payroll information, such as work schedules, pay rates, taxes, net payouts, etc., and is trained to mimic an actual payroll run. To provide statistical guarantees about overpayment to employers, simulations of the payroll process can serve as a feedback loop for the training algorithm. A first layer of the neural network can be dedicated on training the prediction of the available balance, where subsequent layers simulate varying payments based on the computed parameters. In some instances, the network can be optimized for the number and/or amount (or both) of overpayment that is implied.

In some instances, based on the execution of either a payroll simulation (at 965) or a payroll prediction (at 975), an available balance is calculated and can be persisted at the platform service. Further, the available balance can be provided on a user interface of the platform service to the user requested the advance payment.

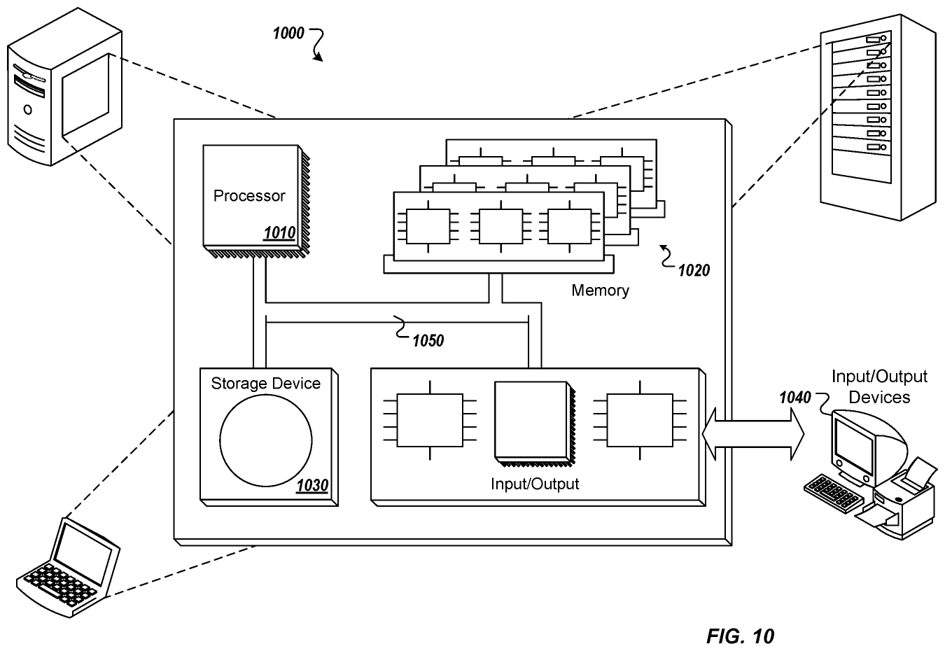

Referring now to FIG. 10, a schematic diagram of an example computing system 1000 is provided. The system 1000 can be used for the operations described in association with the implementations described herein. For example, the system 1000 may be included in any or all of the server components discussed herein. The system 1000 includes a processor 1010, a memory 1020, a storage device 1030, and an input/output device 1040. The components 1010, 1020, 1030, 1040 are interconnected using a system bus 1050. The processor 1010 is capable of processing instructions for execution within the system 1000. In some implementations, the processor 1010 is a single-threaded processor. In some implementations, the processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In some implementations, the memory 1020 is a computer-readable medium. In some implementations, the memory 1020 is a volatile memory unit. In some implementations, the memory 1020 is a non-volatile memory unit. The storage device 1030 is capable of providing mass storage for the system 1000. In some implementations, the storage device 1030 is a computer-readable medium. In some implementations, the storage device 1030 may be a floppy disk device, a hard disk device, an optical disk device, or a tape device. The input/output device 1040 provides input/output operations for the system 1000. In some implementations, the input/output device 1040 includes a keyboard and/or pointing device. In some implementations, the input/output device 1040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer implemented method comprising:
receiving, by a cloud platform service, a request from a user for an advance payment associated with a requested period of time, wherein the cloud platform service is integrated with a plurality of systems storing data for objects of an enterprise, wherein the requested period of time includes working days of the user, and wherein the user is identified as a objects of the enterprise in at least one of the plurality of systems; and
in response to the received request, calculating an available balance amount that can be allocated to the user for the requested period of time, wherein calculating the available balance amount comprises:
determining data associated with the requested period of time to provide a basis for calculating the available balance amount, wherein the data is determined for performed work tasks and compensation to be monetized, and wherein the data is determined at least based on data stored at the at least one of the plurality of systems, wherein the data is associated with a current pay cycle including the requested period of time and one or more other pay cycles for the user; and
calculating the available balance amount based on the determined data according to rules defined at a real time estimation engine defined at the cloud platform service, wherein the rules are for processing the determined data to calculate the available balance amount to comply with predefined criteria; and
providing the calculated available balance amount at a user interface of the cloud platform service.

2. The method of claim 1, wherein the determined data for the compensation includes data for a salary of the requestor, a bonus of the requestor, and eligible benefits assigned to the requestor.

3. The method of claim 1, wherein determining the data associated with the requested period of time comprises:
in response to determining that the data stored at the at least one of the plurality of systems is incomplete for providing the basis for calculating the available balance amount, determining predicted data to replace absent real stored data at the plurality of systems based on the data stored at the at least one of the plurality of systems, wherein the data stored at the at least one of the plurality of systems used to determine the predicted data includes data for a current pay cycle and for at least one previous pay cycle associated with the user.

4. The method of claim 1, further comprising:
instantiating the cloud platform service at a cloud infrastructure environment to receive the request from the user for the advance payment, wherein the cloud platform service is configured to access the plurality of systems in relation to received requests from employees identified at employee records at the plurality of systems.

5. The method of claim 1, wherein the employees are defined as objects at the plurality of systems and stored together with corresponding employee data portions of the employee data, and wherein the employee data comprises data related to the performed work tasks, the eligible benefits, employee identification data, and other employee profile data for the enterprise.

6. The method of claim 1, wherein determining the data associated with the requested period of time comprises:
in response to determining that the data stored at the at least one of the plurality of systems is complete and provides the basis for calculating the available balance amount for the requested period of time, executing a payroll simulation for the employee at the at least one of the plurality of systems.

7. The method of claim 1, wherein determining the data associated with the requested period of time comprises:
in response to determining that the stored data corresponds to a portion of the requested period of time, performing a payroll simulation based on stored data from the at least one of the plurality of systems and prediction data calculated by the cloud platform service, wherein the prediction data is generated according to a prediction model defined at the cloud platform service.

8. The method of claim 1, wherein calculating the available balance amount based on the determined data further comprises:
executing a payroll simulation based on the determined data for the period of time associated with the request, wherein the determined data comprises real data stored at one or more of the plurality of system and predicted data generated according to a predictive model defined at the cloud platform service.

9. A non-transitory, computer-readable medium coupled to one or more processors and having instructions stored thereon which, when executed by the one or more processors, cause the one or more processors to perform operations, the operations comprising:
receiving, by a cloud platform service, a request from a user for an advance payment associated with a requested period of time, wherein the cloud platform service is integrated with a plurality of systems storing data for objects of an enterprise, wherein the requested period of time includes working days of the user, and wherein the user is identified as a objects of the enterprise in at least one of the plurality of systems; and
in response to the received request, calculating an available balance amount that can be allocated to the user for the requested period of time, wherein calculating the available balance amount comprises:
determining data associated with the requested period of time to provide a basis for calculating the available balance amount, wherein the data is determined for performed work tasks and compensation to be monetized, and wherein the data is determined at least based on data stored at the at least one of the plurality of systems, wherein the data is associated with a current pay cycle including the requested period of time and one or more other pay cycles for the user; and
calculating the available balance amount based on the determined data according to rules defined at a real time estimation engine defined at the cloud platform service, wherein the rules are for processing the determined data to calculate the available balance amount to comply with predefined criteria; and
providing the calculated available balance amount at a user interface of the cloud platform service.

10. The computer-readable medium of claim 9, wherein the determined data for the compensation includes data for a salary of the requestor, a bonus of the requestor, and eligible benefits assigned to the requestor, and wherein determining the data associated with the requested period of time comprises:
in response to determining that the data stored at the at least one of the plurality of systems is incomplete for providing the basis for calculating the available balance amount, determining predicted data to replace absent real stored data at the plurality of systems based on the data stored at the at least one of the plurality of systems, wherein the data stored at the at least one of the plurality of systems used to determine the predicted data includes data for a current pay cycle and for at least one previous pay cycle associated with the user.

11. The computer-readable medium of claim 9, further comprising:
instantiating the cloud platform service at a cloud infrastructure environment to receive the request from the user for the advance payment, wherein the cloud platform service is configured to access the plurality of systems in relation to received requests from employees identified at employee records at the plurality of systems.

12. The computer-readable medium of claim 9, wherein the employees are defined as objects at the plurality of systems and stored together with corresponding employee data portions of the employee data, and wherein the employee data comprises data related to the performed work tasks, the eligible benefits, employee identification data, and other employee profile data for the enterprise.

13. The computer-readable medium of claim 9, wherein determining the data associated with the requested period of time comprises:
in response to determining that the data stored at the at least one of the plurality of systems is complete and provides the basis for calculating the available balance amount for the requested period of time, executing a payroll simulation for the employee at the at least one of the plurality of systems; and
in response to determining that the stored data corresponds to a portion of the requested period of time, performing a payroll simulation based on stored data from the at least one of the plurality of systems and prediction data calculated by the cloud platform service, wherein the prediction data is generated according to a prediction model defined at the cloud platform service.

14. The computer-readable medium of claim 9, wherein calculating the available balance amount based on the determined data further comprises:
executing a payroll simulation based on the determined data for the period of time associated with the request, wherein the determined data comprises real data stored at one or more of the plurality of system and predicted data generated according to a predictive model defined at the cloud platform service.

15. A system comprising
a computing device; and
a computer-readable storage device coupled to the computing device and having instructions stored thereon which, when executed by the computing device, cause the computing device to perform operations, the operations comprising:
receiving, by a cloud platform service, a request from a user for an advance payment associated with a requested period of time, wherein the cloud platform service is integrated with a plurality of systems storing data for objects of an enterprise, wherein the requested period of time includes working days of the user, and wherein the user is identified as a objects of the enterprise in at least one of the plurality of systems; and
in response to the received request, calculating an available balance amount that can be allocated to the user for the requested period of time, wherein calculating the available balance amount comprises:
determining data associated with the requested period of time to provide a basis for calculating the available balance amount, wherein the data is determined for performed work tasks and compensation to be monetized, and wherein the data is determined at least based on data stored at the at least one of the plurality of systems, wherein the data is associated with a current pay cycle including the requested period of time and one or more other pay cycles for the user; and
calculating the available balance amount based on the determined data according to rules defined at a real time estimation engine defined at the cloud platform service, wherein the rules are for processing the determined data to calculate the available balance amount to comply with predefined criteria; and
providing the calculated available balance amount at a user interface of the cloud platform service.

16. The system of claim 15, wherein the determined data for the compensation includes data for a salary of the requestor, a bonus of the requestor, and eligible benefits assigned to the requestor, and wherein determining the data associated with the requested period of time comprises:
in response to determining that the data stored at the at least one of the plurality of systems is incomplete for providing the basis for calculating the available balance amount, determining predicted data to replace absent real stored data at the plurality of systems based on the data stored at the at least one of the plurality of systems, wherein the data stored at the at least one of the plurality of systems used to determine the predicted data includes data for a current pay cycle and for at least one previous pay cycle associated with the user.

17. The system of claim 15, further comprising:
instantiating the cloud platform service at a cloud infrastructure environment to receive the request from the user for the advance payment, wherein the cloud platform service is configured to access the plurality of systems in relation to received requests from employees identified at employee records at the plurality of systems.

18. The system of claim 15, wherein the employees are defined as objects at the plurality of systems and stored together with corresponding employee data portions of the employee data, and wherein the employee data comprises data related to the performed work tasks, the eligible benefits, employee identification data, and other employee profile data for the enterprise.

19. The system of claim 15, wherein determining the data associated with the requested period of time comprises:
in response to determining that the data stored at the at least one of the plurality of systems is complete and provides the basis for calculating the available balance amount for the requested period of time, executing a payroll simulation for the employee at the at least one of the plurality of systems; and
in response to determining that the stored data corresponds to a portion of the requested period of time, performing a payroll simulation based on stored data from the at least one of the plurality of systems and prediction data calculated by the cloud platform service, wherein the prediction data is generated according to a prediction model defined at the cloud platform service.

20. The system of claim 15, wherein calculating the available balance amount based on the determined data further comprises:
executing a payroll simulation based on the determined data for the period of time associated with the request, wherein the determined data comprises real data stored at one or more of the plurality of system and predicted data generated according to a predictive model defined at the cloud platform service.
